(19) United States
(12) Patent Application Publication
(10) Pub. No.: US 2025/0370776 A1
(43) Pub. Date: Dec. 4, 2025

(54) SYSTEMS, METHODS, AND APPARATUSES FOR PREDICTIVE PERFORMANCE ANALYSIS

(71) Applicant: Assurant, Inc., New York, NY (US)

(72) Inventors: Harsh Patel, Atlanta, GA (US); Thomas Lynn, Atlanta, GA (US)

(21) Appl. No.: 19/223,796

(22) Filed: May 30, 2025

Related U.S. Application Data
(60) Provisional application No. 63/653,509, filed on May 30, 2024.

(51) Int. Cl. G06F 9/451; G06T 19/00

(52) U.S. Cl. CPC G06F 9/451; G06T 19/006

(57) ABSTRACT

Various embodiments are directed to apparatuses, methods, computer-readable media, computer program products, and systems related to predictive performance analysis. In some embodiments, the method may comprise receiving, by one or more processors and from one or more data sources, unit performance data for an analytical unit; applying, by the one or more processors, the unit performance data to one or more trained performance analysis models to generate a predictive performance data set for the analytical unit by analyzing the unit performance data using the one or more trained performance analysis models; generating, by the one or more processors, one or more renderable virtual widgets comprising one or more representations of at least a portion of the predictive performance data set for the analytical unit; and displaying, by the one or more processors, the one or more renderable virtual widgets on a screen of a user device.

### CROSS-REFERENCE TO RELATED APPLICATIONS

This application claims priority to U.S. Provisional Patent Application No. 63/653,509 entitled “SYSTEMS, METHODS, AND APPARATUSES FOR PREDICTIVE PERFORMANCE ANALYSIS,” filed May 30, 2024, which is incorporated herein by reference in its entirety.

### FIELD OF THE INVENTION

The present disclosure relates to systems, methods, and apparatuses for predictive performance analysis. Example embodiments are directed to system, methods, and apparatuses, for generating predictive performance data sets for analytical units.

### BACKGROUND

Performance analysis is essential in many applications and environments, and performance analysis may be hindered by deficiencies, particularly at scale and in real time analysis scenarios. Applicant has identified a number of additional challenges associated with performance analysis for analytical units. Through applied effort, ingenuity, and innovation many deficiencies of existing systems have been solved by developing solutions that are in accordance with the embodiments as discussed herein, many examples of which are described in detail herein.

### BRIEF SUMMARY

In general, embodiments of the present disclosure provided herein may relate to predictive performance analysis. Other implementations for predictive performance analysis will be, or will become, apparent to one with skill in the art upon examination of the following figures and detailed description. It is intended that all such additional implementations be included within this description be within the scope of the disclosure and be protected by the following claims.

Various embodiments are directed to apparatuses, methods, computer-readable media, computer program products, and systems related to predictive performance analysis. Various embodiments may include a computer-implemented method comprising: receiving, by one or more processors and from one or more data sources, unit performance data for an analytical unit; applying, by the one or more processors, the unit performance data to one or more trained performance analysis models to generate a predictive performance data set for the analytical unit by analyzing the unit performance data using the one or more trained performance analysis models; generating, by the one or more processors, one or more renderable virtual widgets comprising one or more representations of at least a portion of the predictive performance data set for the analytical unit; and displaying, by the one or more processors, the one or more renderable virtual widgets on a screen of a user device. In various embodiments, the user device comprises an augmented reality device, wherein the computer-implemented method further comprises detecting, a first location in a field of view of the augmented reality device within a spatial region associated with the analytical unit, wherein displaying the one or more renderable virtual widgets on the screen of the user device comprises displaying the one or more renderable virtual widgets on the screen of the augmented reality device in response to detecting the first location of the augmented reality device, wherein the at least a portion of the predictive performance data set for the analytical unit comprises a portion of the predictive performance data set that is associated with the first location; detecting a second location in the field of view of the user device within the spatial region; and in response to detecting the second location, displaying, on the screen of the augmented reality device, one or more representations of a second portion of the predictive performance data set that is associated with the second location. In various embodiments, displaying the one or more renderable virtual widgets on the screen of the user device comprises displaying the one or more renderable virtual widgets in an interface on the screen of the user device. In various embodiments, the interface includes at least one communications interface element, wherein the computer-implemented method is further configured to: in response to user interaction with the communications interface element, cause rendering of a communications widget on the screen of the user device to facilitate transmitting and/or receiving of messages between the user device and a second user device. In various embodiments, receiving the unit performance data comprises receiving client performance data comprising a plurality of individual unit performance data associated with a plurality of analytical units; and applying the unit performance data to one or more data extraction models to identify the unit performance data from the plurality of individual unit performance data. In various embodiments, generating the predictive performance data set for the analytical unit comprises applying the unit performance data to a first trained performance analysis model to generate a first subset of the predictive performance data set, wherein the first subset of the predictive performance data set includes performance metrics insights; and applying the performance metrics insights to a second performance analysis model to generate a second subset of the predictive performance data set, wherein the second subset includes performance optimization insights. In various embodiments, the one or more representations of the at least a portion of the predictive performance data set for the analytical unit includes a textual representation of performance improvement recommendations for the analytical unit, wherein the textual representation of the performance improvement recommendations is generated using a generative artificial intelligence model of the one or more trained performance analysis models and based on the at least a portion of the predictive performance data set for the analytical unit. In various embodiments, the performance improvement recommendations comprise training data for the analytical unit, wherein the training data is generated in response to determining that the unit performance data for the analytical unit fails to satisfy one or more performance targets. In various embodiments, the computer-implemented method further comprises generating, by the generative artificial intelligence model, a training engine comprising the training data for the analytical unit. In various embodiments, the computer-implemented method further comprises generating an alert in response to determining that the unit performance data for the analytical unit fails to satisfy the one or more performance targets, wherein generating the alert comprises displaying a visual indicator via the one or more renderable virtual widgets. In various embodiments, generating the predictive performance data set further comprises generating aggregated data set comprising unit performance data set associated with one or more second analytical units; and generating based on the unit performance data for the analytical unit and aggregated data set, a portion of the predictive performance data set by comparing matching portions of the unit performance data and the aggregated data set, wherein the portion of the predictive performance data set is indicative of a performance of the analytical unit with respect to one or more performance categories and the one or more second analytical units.

Various embodiments may include a system for predictive performance analysis, the system comprising one or more processors and at least one non-transitory memory comprising instructions that, with the one or more processors, cause the system to: receive, from one or more data sources, unit performance data for an analytical unit; apply the unit performance data to one or more trained performance analysis models to generate a predictive performance data set for the analytical unit by analyzing the unit performance data using the one or more trained performance analysis models; generate one or more renderable virtual widgets comprising one or more representations of at least a portion of the predictive performance data set for the analytical unit; and display the one or more renderable virtual widgets on a screen of a user device. In various embodiments, the user device comprises an augmented reality device, wherein the system is further caused to: detect a first location in a field of view of the augmented reality device within a spatial region associated with the analytical unit, wherein displaying the one or more renderable virtual widgets on the screen of the user device comprises displaying the one or more renderable virtual widgets on the screen of the augmented reality device in response to detecting the first location of the augmented reality device, wherein the at least a portion of the predictive performance data set for the analytical unit comprises a portion of the predictive performance data set that is associated with the first location; detect a second location in the field of view of the user device within the spatial region; and in response to detecting the second location, display, on the screen of the augmented reality device, one or more representations of a second portion of the predictive performance data set that is associated with the second location. In various embodiments, displaying the one or more renderable virtual widgets on the screen of the user device comprises displaying the one or more renderable virtual widgets in an interface on the screen of the user device. In various embodiments, the interface includes at least one communications interface element, wherein the system is further caused to: in response to user interaction with the communications interface element, cause rendering of a communications widget on the screen of the user device to facilitate transmitting and/or receiving of messages between the user device and a second user device. In various embodiments, receiving the unit performance data comprises receiving client performance data comprising a plurality of individual unit performance data associated with a plurality of analytical units; and applying the unit performance data to the one or more trained performance analysis models to identify the unit performance data from the plurality of individual unit performance data. In various embodiments, generating the predictive performance data set for the analytical unit comprises applying the unit performance data to a first trained performance analysis model to generate a first subset of the predictive performance data set, wherein the first subset of the predictive performance data set includes performance metrics insights; and applying the performance metrics insights to a second performance analysis model to generate a second subset of the predictive performance data set, wherein the second subset includes performance optimization insights. In various embodiments, the one or more representations of the at least a portion of the predictive performance data set for the analytical unit includes a textual representation of performance improvement recommendations for the analytical unit, wherein the textual representation of the performance improvement recommendations is generated using a generative artificial intelligence model of the one or more trained performance analysis models and based on the at least a portion of the predictive performance data set for the analytical unit. In various embodiments, the performance improvement recommendations comprise training data for the analytical unit, wherein the training data is generated in response to determining that the unit performance data for the analytical unit fails to satisfy one or more performance targets. In various embodiments, the system further comprises generating, by the generative artificial intelligence model, a training engine comprising the training data for the analytical unit.

### BRIEF DESCRIPTION OF THE DRAWINGS

Reference will now be made to the accompanying drawings, which are not necessarily drawn to scale, and wherein:

FIG. 1 illustrates an example system environment within which at least some embodiments of the present disclosure may operate;

FIG. 2 illustrates a block diagram of an apparatus that may be specifically configured, within which at least some embodiments of the present disclosure may operate;

FIG. 3 illustrates an example data flow diagram showing example data structures for data ingestion in accordance with at least some embodiments of the present disclosure;

FIGS. 4A-B illustrate an example data flow diagram showing example data structures for predictive performance data set generation process in accordance with at least some embodiments of the present disclosure;

FIG. 5 illustrates an example flowchart depicting operations for predictive performance analysis in accordance with at least some embodiments of the present disclosure;

FIG. 6 illustrates an example performance user interface that may be provided in accordance with at least some embodiments of the present disclosure;

FIG. 7 illustrates an example performance optimization insights interface that may be provided in accordance with at least some embodiments of the present disclosure.

FIG. 8 illustrates an example performance metrics insights interface that may be provided in accordance with at least some embodiments of the present disclosure;

FIG. 9 illustrates an example performance user interface that may be provided in accordance with at least some embodiments of the present disclosure;

FIGS. 10-14 each illustrate an AR screen in accordance with at least some embodiments of the present disclosure;

FIG. 15 illustrates another example performance user interface in accordance with at least some embodiments of the present disclosure; and

FIGS. 16A-C illustrate another example performance user interface in accordance with at least some embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. While values for dimensions of various elements may be disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

### Overview

The present disclosure relates to performing predictive performance analysis for analytical units associated with a client entity to generate predictive performance data sets. The client entity, for example, may include a network, system, or other logical arrangement of the one or more analytical units that, individually or collectively, perform tasks geared towards providing an output. The predictive performance data sets may include performance insights that identifies faults, issues, opportunities for improvements, and/or opportunities for increased throughput to name a few.

Example embodiments may receive unit performance data for an analytical unit from one or more data sources. For example, some embodiments, may extract the unit performance data for the analytical unit from client performance data. Example embodiments may leverage one or more data extraction models to extract the unit performance data. Example embodiments may apply the unit performance data to one or more trained performance analysis models to generate a predictive performance data set for the analytical unit. For example, the unit performance data for the analytical unit may be provided as an input to the trained performance analysis models. In some embodiments, client entity performance data may be collectively fed into the trained performance analysis model to extract analysis for the analytical units. The client entity performance data may include unit performance data for a plurality of analytical units, which may include one or more layers of detail (e.g., individual unit performance data and/or unit performance data associated with one or more collective groups of analytical units).

The trained performance analysis models may then analyze the unit performance data using one or more algorithms, such as machine learning algorithms according to one or more of the embodiments disclosed herein, to generate the predictive performance data set. In some embodiments, two or more of the trained performance analysis models may define or otherwise form a performance analysis model pipeline (e.g., connected model framework) in that the output of one performance analysis model may be at least a portion of the input to another performance analysis model. For example, in some embodiments, a set of one or more performance analysis models may be configured to generate performance metrics insights for an analytical unit which are then fed into a second set of one or more performance analysis models configured to generate performance optimization insights for the analytical unit. In some embodiments, one or more performance analysis models may be configured to generate performance metrics insights for an analytical unit which are then fed into one or more generative artificial intelligence models, the output of which may comprise or may be used to generate one or more renderable virtual widgets.

Alternatively or additionally, in some embodiments, one or more performance analysis models may be configured to generate respective portions of the predictive performance data set in parallel. For example, in some embodiments, a set of one or more performance analysis models may be configured to generate a first portion of the predictive performance data set for an analytical unit (which, for example, may comprise the performance metrics insights for the analytical unit) while a second set of one or more performance analysis models may be configured to generate a second portion of the predictive performance data set for the analytical unit (which, for example, may include performance optimization insights for the analytical unit).

In some embodiments, the trained performance analysis models may include one or more generative artificial intelligence models. Alternatively or additionally, in some embodiments, the trained performance analysis models may include one or more artificial neutral networks and/or other machine learning models. In some embodiments, the generated predictive performance data set may include performance metrics insights such as throughput data, unit capacity utilization data, behavior data, to name a few. Additionally, in some embodiments, the generated predictive performance data set for an analytical unit include performance optimization insights such performance ranks for different performance categories, performance diagnostics data (e.g., identified faults, issues, root cause, etc.), and/or performance improvement recommendations to name a few.

The performance analysis models may be configured to analyze the various portions of the unit performance data for analytical unit, individually or collectively with one or more other portions of the unit performance data, to generate the predictive performance data set for the analytical unit. For example, in some embodiments, a portion of the unit performance data for an analytical unit may include data associated with a third-party entity (e.g., a third-party entity, such as one or more third party analytical units, which may be linked with the analytical unit, linked with other analytical units of the client entity, linked with analytical units of other client entities, or not linked with any client entity). In some embodiments, one or more performance analysis models may be leveraged to analyze the third-party entity data to generate predictive performance data associated with the third-party entity. In some embodiments, the third-party entity data and/or predictive performance data associated with the third-party entity may be added to the set of unit performance data for the analytical unit or otherwise used alone or in combination with other unit performance data to generate predictive performance data sets for the analytical unit.

In some embodiments, one or more performance analysis models may be leveraged to analyze the third-party entity data to generate behavior data that is then analyzed along with one or more other portions of the unit performance data for the analytical unit to generate at least a portion of the predictive performance data set for the analytical unit. Such portion of the predictive performance data set that is generated based at least in part on the behavior data may include performance improvement recommendations, such as opportunities to increase throughput of the analytical unit, or the like. In some embodiments, this may include predicting linked units that are likely to increase throughput of the analytical unit if linked with the analytical unit based on the behavior data associated with the third-party entity. For example, analysis of the historical performance data for an analytical unit along with behavior data associated with candidate third-party entities may be leveraged to identify matching third-party entities with respect to increasing throughput of the analytical unit. The behavior data associated with the candidate third-party entities, for example, may be compared to behavior data associated with linked third-party entities that are deemed matching third-party entities to identify additional matching third-party entities from the candidate third-party entities (e.g., matching third-party entities sharing similar behavior data and/or similar metadata is indicative of a compatibility with the analytical unit(s)). For example, predictive performance data sets may be generated at least in part by comparing the third-party entity data associated with the analyzed analytical unit (e.g., third party computing systems or users interacting with the analytical unit) with third party entity data associated with other analytical units. For example, where the analytical unit is a sales agent, one or more performance analysis models may be configured to analyze data associated with one or more users or customers of the client entity (or one or more individual analytical units) or potential users or customers to generate recommendations (e.g., leads) for the sales agent by predicting the customers that are likely to yield successful transactions if engaged by the sales agent.

As another example, a portion of the unit performance data may include output data (e.g., processing data for a processor, sales data for a sales agent, or the like), product data (e.g., product category, product code, and/or the like), location data for the analytical unit (e.g., location identifier, or the like), and/or analytical unit identification data (e.g., analytical unit identifier, or the like) that may be input into and analyzed by one or more performance analysis models to generate at least a portion of the predictive performance data set for the analytical unit in accordance with the various embodiments herein.

In some embodiments, one or more performance analysis models may be leveraged to generate at least a portion of the predictive performance data set for the analytical unit by comparing the unit performance data for the analytical unit with unit performance data for other analytical units of the client entity associated with the analytical unit and/or comparing unit performance data for the analytical unit with unit performance data for other analytical units of other client entities. For example, a portion of the predictive performance data set for an analytical unit may include performance ranks for the analytical unit, where the performance ranks may be generated by comparing, using one or more performance analysis models, unit performance data for the analytical unit with unit performance data for other analytical units of the client entity associated with the analytical unit and/or comparing unit performance data for the analytical unit with unit performance data for other analytical units of other client entities. The performance ranks or other comparative predictive performance data may include a plurality of performance types (e.g., performance categories) with one or more predictive performance data sets associated with each to granularize the model output and generate specific predictive performance data and/or renderable virtual widgets for each performance type.

Example embodiments may generate renderable virtual widgets comprising representations of the generated predictive performance data set. In some embodiments, a given virtual widget may include representations of a portion (e.g., some, all) of the predictive performance data set for an analytical unit or a group of analytical units. The predictive performance data set may be presented to a user via the virtual widgets in a variety of forms. For example, the virtual widgets may include natural language textual representations, graph representations, chart representations, etc. of the predictive performance data sets for analytical units. For example, a generative artificial intelligence model or other machine learning model may be leveraged to generate textual representations of portions of the predictive performance data set.

Example embodiments may display the virtual widgets on a screen of a user device. In some embodiments, the predictive performance data set for an analytical unit that is provided to a user (e.g., displayed via virtual widgets on a screen of a user device associated with the user) may be generated based on a user identifier and/or one or more other data sets associated with the user, such that different users may receive different predictive performance data sets for the same one or more analytical units (e.g., predictive performance data sets tailored for specific users).

In some embodiments, tailoring the predictive performance data set that is provided to a user may include applying the predictive data set and user data (e.g., user identifier, user role, user permissions data, or the like) associated with the user to a performance analysis model that is configured to extract and/or analyze portions of the predictive data set for the analytical unit that is relevant to the user based on the user data. In some embodiments, tailoring the predictive performance data set that is provided to a user may include generating the predictive performance data set for an analytical unit based at least in part on user data associated with the user whom the predictive performance data set will be provided, where the predictive performance data set generated for the analytical unit with respect to a first user may be different from the predictive performance data set generated for the analytical unit with respect to a second user. For example, in such embodiments, the input to the one or more performance analysis models may include the user data. In this regard, example embodiments of the present disclosure may receive client entity data and provide, using one or more performance analysis models, predictive performance data sets for one or more users, where each predictive performance data set provided to a user comprise performance insights that are relevant to the respective user. For example, a network engineer may receive performance insights that include network efficiency improvement recommendations while the site manager may receive performance insights that include staffing recommendations. As another example, a first user or system associated with core temperature monitoring of a computer system may receive predictive performance data set relevant to optimizing the core temperature of the analytical unit while a second user or system associated with storage space capacity may receive predictive performance data set relevant to optimizing the storage space of the analytical unit, in some instances based on the same initial unit performance data. In some embodiments, one user may receive predictive performance data sets and/or virtual widgets associated with a client entity and/or a plurality of analytical units.

Example embodiments may display the virtual widgets in an interface on the screen of the user device. The interface may be associated with a platform (e.g., mobile application platform, web application platform, or the like) provided by the system of the present disclosure. In some embodiments, an example interface may include at least one communications interface element. For example, in some embodiments, the interface may include graphical tiles that are each associated with a portion of the predictive performance data set. Each graphical tile may include its own communications interface element. In response to user interaction with the respective communications interface element, example embodiments may cause rendering of a communications widget on the screen of the user device to facilitate transmitting and/or receiving of messages between the user device and a second user device. For example, two or more users may receive the same performance insights and may collaborate via the communications widget to discuss and/or track progress with respect to, for example, implementing the performance recommendations. In some embodiments, the respective users may receive a request via the communications widget to collaborate with respect to the received performance insights.

Example embodiments may provide for display of the virtual widgets in augmented reality (“AR”). For example, where the user device is an AR device configured to render an AR interface on a screen, example embodiments may display the virtual widgets on the screen of the AR device. The virtual widget(s) displayed on the screen of the AR device may depend on the location in the field of view of the AR device. For example, in some embodiments a first virtual widget may be displayed on the screen of the AR device in response to detecting a first location in the field of view of the augmented reality device within a spatial region (e.g., premises) associated with at least one analytical unit. In some embodiments, the virtual widgets may include tiles configured to appear and be consistently maintained at a location within the environment depicted by the AR device as the user moves the AR device. As the AR device scans the spatial region or otherwise based on location or field of view data, example embodiments may detect a second location within the field of view of the AR device that is associated with another analytical unit or group of analytical units. In response to detecting the second location, a second virtual widget(s) comprising the predictive performance data sets or a portion thereof for at least one analytical unit associated with the second location may be displayed on the screen of the AR device.

Example embodiments may leverage various portions of unit performance data and one or more analysis techniques to generate predictive performance data sets for analytical units. The predictive performance data sets may provide various insights as well as facilitate, and/or provide various capabilities configured to improve performance of individual analytical units as well as overall performance of a client entity. For example, the predictive performance data set for analytical units may include performance ranks configured to at least facilitate comparison among similar analytical units, facilitate a reward system, and/or serve as an incentive mechanism for analytical units. As another example, the predictive performance data set for analytical units may include performance improvement recommendations such as areas of opportunities for improvement, corrective actions to resolve faults/issues, training recommendations, training data, re-configuration data, resource allocation recommendations, resource assignment recommendations, operating plan recommendations, training engine tailored to an analytical unit, or the like.

Embodiments of the present disclosure may be used in a plurality of domains, applications, environments, and/or architecture and not limited to any specific domain, application, environment, and/or architecture. For example, in an example domain where the analytical units are sales agents, example embodiments, using techniques discussed herein, may assess current performance of the sales agents; provide peer to peer comparison rankings; provide customized performance improvement recommendations; leverage weighted performance metrics to identify areas of opportunities across sales channels; leverage sales forecasts, projections, and what-if scenario builders for performance analysis; perform dynamic benchmarking using industry data; leverage peer to peer comparison rankings to facilitate recognition and awards-based systems, perform multi-target sales monitoring; facilitate and/or provide digital optimization, facilitate development of expertise on products, pricing, and benefits; analyze cross selling opportunities for related products; facilitate geographical interactivity (e.g., using spatial area segmentation and mapping, customer/user proximity, hierarchical site/store analysis); track and analyze post-sale customer behavior (e.g., insights on customer experience ratings, policy quality sales, remorse tracking, etc.); facilitate suspicious activity tracking; facilitate loss management (e.g., forward and reverse logistics to reduce losses due to misdirected or lost product); create training engines based on identified areas of improvement personalized to match agent's learning style in order to maximize upskilling efficiency; and the like.

Various technical improvements will be appreciated from the present disclosure For example, example embodiments of the present disclosure ingest performance data of various data types and/or data sources at a client entity level and/or at sub-increment levels of the client entity, generate holistic predictive performance data sets at the various levels, and dynamically provide the predictive performance data sets to users in a single dynamic platform via renderable virtual widgets. The embodiments described herein are able to modularly and dynamically react to different data source inputs to generate outputs. In this regard, embodiments of the present disclosure improve the technological field of performance data analysis at least by providing holistic and reliable predictive performance data sets that are accessible to users via a single platform which obviates the need for users to consult multiple platforms to access necessary data. This, in turn, reduces network traffic and unnecessary usage of computing resources. Embodiments of the present disclosure further provide technical improvements by leveraging trained performance analysis models and specially configured framework to generate meaningful and relevant insights from unrefined client pool of data (e.g., a transformative layer configured to pipeline data from a plurality of disparate sources into one or more performance analysis models for generating predictive performance data and/or renderable virtual widgets for one or more layers of client entity and/or analytical unit(s)). Such embodiments may further be retrofit onto existing performance analysis frameworks to expand the pool of available unit performance data for existing renderable virtual widget generators and/or performance analysis models.

Embodiments of the present disclosure further provide technical improvements in the field of graphical user interfaces and augmented reality by at least (i) providing for visualization of performance insights tailored to the user in an efficient manner via virtual widgets renderable in a user interface of an application platform (e.g., mobile application platform, web application platform, or the like) as well as renderable in an AR environment, and/or (ii) in a manner that allows for seamlessly transition between the application platform and the AR environment. Embodiments of the present disclosure further provide technical improvements in the field of graphical user interfaces by providing communication interface elements and communication widgets in a user interface which, with the aforementioned systems and processes, allow for real-time communication among users directed at the tailored predictive performance data and/or renderable virtual widgets. Furthermore, by providing holistic and reliable predictive performance data sets as described above, embodiments of the present disclosure facilitate various capabilities including performance improvement of analytical units and overall client entity performance.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data object,” or “data set” refer interchangeably to data capable of being transmitted, received, and/or stored.

As used herein, the term “machine learning model” refers to one or more processes, algorithms, and/or other data entity that describes parameters, hyper-parameters, defined operations, and/or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, support vector machines, gradient boosts, Markov models, adaptive Bayesian techniques, and statistical models (e.g., timeseries-based forecast models such as autoregressive models, autoregressive moving average models, and/or an autoregressive integrating moving average models). Additionally, and without limitation, an MDA, as used in the singular, may include ensembles using multiple machine learning and/or statistical techniques.

As used herein, the term “analytical unit” refers to an entity for which predictive performance analysis may be performed to generate a predictive performance data set comprising at least performance insights for the analytical unit to, for example, optimize the performance of the analytical unit and/or client entity associated with the analytical unit. In some embodiments, an analytical unit may be associated with one or more real-world and/or virtual tasks for which the predictive performance analysis may be performed. For example, an analytical unit may be configured, trained, and/or the like to, individually and/or collectively with one or more other analytical units, perform one or more tasks, operations, or the like, to generate one or more outputs (e.g., products, services, functionalities, or the like) associated with the client entity. Alternatively or additionally, an analytical unit may be configured, trained, and/or the like to monitor and/or track the results, effects, successes, of the one or more outputs and/or other analytical units. Data associated with the outputs and/or the tasks may be collected, with or without other data, to facilitate the predictive performance analysis. Non-limiting examples of analytical units include a server configured to provide one or more computing services, a computer program configured to provide one or more software functionalities, a sales agent trained to perform one or more activities related to offering of products and/or services, a storage system configured to store data, a software developer agent trained to perform one or more activities related to software application development and/or deployment, or the like. In some examples, an analytical unit may be associated with a client entity. For example, an analytical unit may represent a component and/or resource of a client entity. In a product and/or service provider domain, for example, an analytical unit may be a sales agent of a retail store, a store manager of a retail store, a retail store building, a product manufacturing building, an operating machine, a point of sale (POS) device, or the like.

In some examples, an analytical unit may be associated with an analytical unit identifier. As used herein, the term “analytical unit identifier” refers to one or more items of data by which an analytical unit may be uniquely identified from other analytical units. An analytical unit identifier may comprise ASCII text, a pointer, a memory address, and/or other data that uniquely identifies a particular analytical unit.

As used herein, the term “client entity” refers to an entity that may include one or more analytical units. A client entity may be configured to generate and/or provide one or more outputs (e.g., products, services, functionalities, or the like). For example, the client entity may include one or more analytical units configured to perform individual and/or coordinated functions, tasks, or activities associated with the client entity to generate the one or more outputs. A client entity may include a network, system, or other logical arrangement of the one or more analytical units. For example, the one or more analytical units may represent components and/or resources of the client entity. Non-limiting examples of a client entity include operating machines/equipment (e.g., spring coiling machines, grinding machines, industrial ovens, printing machines, or the like), computing systems (e.g., server systems, communications network systems, storage systems, mobile devices, software applications, operating systems, or the like), product and/or service providers (e.g., businesses, organizations, corporations, or the like), or the like. In some examples, a client entity may itself be an analytical unit of another client entity. In a computing system domain, for example, a server may be an analytical unit of a client entity that is distributed server system and may as well be a client entity associated with one or more analytical units such as a processor, a memory device, or the like. As another example, in a product and/or service provider domain, a retail store may be an analytical unit of a client entity that is mobile device provider and may as well be a client entity associated with one or more analytical units such as sales agents, mobile device-related software applications, or the like. In this regard, one or more performance analysis techniques described herein is configured to provide performance data analysis for a client entity at different levels of granularity.

In some examples, a client entity may be associated with a client entity identifier. As used herein, the term “client entity identifier” refers to one or more items of data by which a client entity may be uniquely identified from other client entities. In some embodiments, a client entity identifier may comprise ASCII text, a pointer, a memory address, and/or other data that uniquely identifies a particular client entity.

As used herein, the term “unit performance data” refers to data associated with an analytical unit, including data generated by the analytical unit and/or data generated about the analytical unit. Non-limiting examples of unit performance data include unit output data that describes data related to transactions associated with the analytical unit (e.g., over a specified time period) such as for example, the quantity of output by the analytical unit over a specified time period (e.g., number of springs output by a coiling machine over N hours of operation that is received by a downstream process and related data, number of printed sheets output by a printing machine over N hours of operation that is received by a downstream process and related data, number of computing tasks from a processing queue that is successfully processed by a processor over a specified time period, number of sales made by a sales agent over a specified time period and related data, or the like); unit capacity data for an analytical unit that describes estimated throughput for the analytical unit (e.g., opportunity data in a product and/or service provider domain example); unit claims data that describes data related to certain post transaction events associated with the client entity (e.g., number of return claims and related data in a product and/or service provider domain example); unit historical performance data for the analytical unit; unit performance target data for the analytical unit; domain data that describes data associated with client entities and/or analytical units having particular characteristics in common, such as, for example, market trend data; policy data that describe procedures, rules, regulations, principles of action, or the like adopted by a client entity associated with the analytical unit; third-party data that describe data about third-party entities that may engage in a transaction with a client entity (e.g., via analytical units of the client entity) or have previously engage in a transaction with the client entity. For example, in a product and/or service provider domain, third-party data may include data about a current customer, previous customer, or potential customer of a client entity. Third-party data may include linked third-party data with respect to an analytical unit. As used herein, the term “linked third-party data” and similar terms may describe third-party data of a third-party entity that is associated with one or more analytical units such as, for example, a previous customer or current customer of an analytical unit and/or a client entity or portion of a client entity (e.g., a spatial region). In some examples, the unit performance data may include metadata for the analytical unit and/or linked third party such as location information, time of day, and/or the like.

Unit performance data for an analytical unit may be obtained from one or more data sources. For example, a first data source may store a portion of the unit performance data for an analytical unit while a second data source may store another portion of the unit performance data for the analytical unit. In some examples, a single data source may store the unit performance data for an analytical unit. In some examples, unit performance data may be subset of client performance data. For example, unit performance data may be extracted from client performance data in some embodiments. In some examples, the unit performance data for an analytical unit may be obtained from the one or more data sources and stored in a repository or storage subsystem. In some examples, unit performance data for an analytical unit may be leveraged by a performance analysis computing system to generate a predictive performance data set for the analytical unit.

As used herein the term “client performance data” refers to data associated with a client entity, including data generated by the client entity and/or data generated about the client entity. Such data may include unit performance data for analytical units associated with the client entity. For example, client performance data may include a collection of one or more unit performance data. Client performance data for a particular client entity, for example, may include unit performance data for one or more analytical units of the particular client entity. Additionally, in some examples, client performance data may include data related to a domain associated with the client entity. Client performance data may include data that may be leveraged by a performance analysis computing system to generate predictive performance data sets for analytical units associated with the client entity and/or for the client entity.

As used herein, the term “predictive performance data set” refers to model output generated for an analytical unit by one or more trained performance analysis models. For example, a predictive performance data set may be generated by inputting unit performance data into a trained performance analysis model configured to output a predictive performance data set by analyzing the unit performance data. The predictive performance data set may include any output of the trained performance analysis model, including analytical outputs, recommendations, or conclusions based on unit performance data and/or one or more sets of unit performance data programmatically selected for its analytical or predictive value. For example, the predictive performance data set may include performance optimization insights for an analytical unit. Non-limiting examples of performance optimization insights include performance rank; capacity utilization data for one or more output categories; performance diagnostics data (e.g., performance issues, root cause of performance issues, low performance contributing factors, high performance contributing factors, or the like); customized performance improvement recommendations (e.g., fine-tuning and/or training recommendations including training data, re-configuration data, resource allocation and/or re-allocation recommendations, corrective action recommendations, or the like), and/or the like. Additionally, the predictive performance data set may include performance metrics insights. Non-limiting examples of performance metrics insights include unit throughput (e.g., quantity of output by an analytical unit); unit capacity utilization (e.g., capacity utilized by an analytical unit); claims rate (e.g., number of post output claims associated with the analytical unit), or the like. In some embodiments, one or more renderable virtual widgets each comprising one or more representations of at least a portion of the predictive performance data set for an analytical unit is displayed on a screen of a user device. As used herein, the term “representation” refers to a data entity that describes a visual presentation of data (e.g., predictive performance data set) or a portion thereof on a screen of a user device and in a particular form. Examples of representations include graphical representations, textual representations, chart representations, pictorial representations, or the like. In some examples, predictive performance data set for one or more analytical units associated with a client entity may be leveraged to generate a predictive performance data set for the client entity.

As used herein, the term “user device” refers an electronic computing device that may be used by a user for any of a variety of purposes including, but not limited to, one or more of sending and/or receiving signals, storing data, displaying data, viewing data, or initiating predictive performance analysis computing task(s). For example, the user device may be capable of, but not limited to, one or more of displaying renderable virtual widgets on the screen of the user device, receiving user input that triggers predictive performance data analysis task(s), determining and/or receiving location data that triggers dynamic update of a screen of the user device and/or information displayed on the screen of the user device, or delivering representations of a predictive performance data set to a user. The user device may include computer hardware and/or software configured to perform one or more functionalities associated with the user device. In some examples, the user device may be a mobile device. As used herein, the term “mobile device” refers to a user device that is capable of being held and transported by a user. Example mobile devices include, but not limited to, smart phones, tablet computers, laptop computers, wearables, laptop computers, or the like. Alternatively or additionally, the user device may be an augmented reality (AR) device. As used herein, the term “augmented reality device” or “AR device” refers to a user device that is capable of providing interactive virtual adaptation of a real-world environment. Example AR devices include, but not limited to, AR smart glasses, AR headsets, AR smart phones, AR tablets, or the like. In some examples, the user device may include one or more sensors, systems, or the like configured for determining location data or otherwise location of the user device. For example, the user device may include a global position system (GPS) and/or other sensor systems or devices configured to determine the absolute location data for the user device.

As used herein, the term “performance category” refers to a data entity that describes a category for assessing the performance of an analytical unit.

As used herein, the term “alert” refers to signals, messages, warnings, cautions, or the like generated by a performance analysis computing system. An alert may be indicative of an error or problem, such as a low performance, abnormality, issue, or the like associated with an analytical unit. In some examples, an alert may be generated based on the predictive performance data set for the analytical unit. For example, an alert may be generated in response to determining that at least a portion of the predictive performance data set fails to satisfy one or more performance targets. For example, an alert may be generated in response to determining that a performance metric for a particular performance target fails to satisfy a performance target for the particular performance target.

As used herein, the term “data ingestion model” refers to one or more rules-based and/or machine learning models configured to extract client performance data from one or more data source. In some embodiments, data ingestion model may include any type of model configured, trained, and/or the like to extract client performance data, including one or more supervised, unsupervised, semi-supervised, reinforcement learning models, and/or the like.

As used herein, the term “data extraction model” refers to one or more rules-based and/or machine learning models configured to extract unit performance data from client performance data. In some embodiments, data extraction model may include any type of model configured, trained, and/or the like to extract unit performance data, including one or more supervised, unsupervised, semi-supervised, reinforcement learning models, and/or the like.

As used herein, the term “trained performance analysis model” refers to one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to generate or facilitate generation of predictive performance data sets and related predictions, data, and other outputs. A trained performance analysis model may include artificial intelligence algorithms and techniques, including machine learning. A trained performance analysis model may be configured, trained, and/or the like to generate a predictive performance data set for an analytical unit based on unit performance data for the analytical unit. For example, a trained performance analysis model may be configured, trained, and/or the like to receive unit performance data, analyze the unit performance data, and output predictive performance data set(s) based on the analysis of the unit performance data. In some examples, a trained performance analysis model may include multiple models configured to perform one or more different stages of a performance analysis. For example, a trained performance analysis model may include (i) a first model configured to receive unit performance data and process the unit performance data to identify, extract, and/or generate performance metrics insights and (ii) a second model configured to receive the performance metrics insights and analyze the performance metrics insights to generate a predictive performance data set. A trained performance analysis model may include one or more of any type of machine learning models including one or more supervised, unsupervised, semi-supervised, reinforcement learning models, and/or the like. In some examples, a trained performance analysis model of one or more trained performance analysis models includes a generative artificial intelligence model, an artificial neutral network, or the like.

As used herein, the term “generative artificial intelligence model” refers to one or more artificial intelligence models, including but not limited to some example machine learning models, configured to generate new outputs in response to a prompt or other input data. In some embodiments, generative artificial intelligence model may include any type of model configured, trained, and/or the like to generate a natural language text, images, video, widgets, or the like in response to a prompt. For example, the generative artificial intelligence model may include a large language model such as a generative pre-trained transformer (GPT) model.

As used herein, the term “metric extraction model” refers to trained performance analysis model configured to generate performance metrics insights based on unit performance data. In some embodiments, metric extraction model may include any type of model configured, trained, and/or the like to generate performance metrics insights, including one or more supervised, unsupervised, semi-supervised, reinforcement learning models, and/or the like.

As used herein, the term “ranking model” refers to trained performance analysis model configured to generate performance ranks based on performance metrics insights and/or based on unit performance data. In some embodiments, ranking model may include any type of model configured, trained, and/or the like to generate performance ranks, including one or more supervised, unsupervised, semi-supervised, reinforcement learning models, and/or the like.

As used herein, the term “diagnostics model” refers to trained performance analysis model configured to generate performance diagnostics data based on performance metrics insights and/or based on unit performance data. In some embodiments, diagnostics model may include any type of model configured, trained, and/or the like to generate performance diagnostics data, including one or more supervised, unsupervised, semi-supervised, reinforcement learning models, and/or the like.

As used herein, the term “recommendation model” refers to trained performance analysis model configured to generate performance improvement recommendations based on performance metrics insights and/or based on unit performance data. In some embodiments, recommendation model may include any type of model configured, trained, and/or the like to generate performance improvement recommendations, including one or more supervised, unsupervised, semi-supervised, reinforcement learning models, and/or the like. In some embodiments, the recommendation model comprises one or more artificial neural networks. In some embodiments, at least one or more inputs to the recommendation model may include unit performance data for the analytical unit, and performance metrics insights for the analytical unit. In some embodiments, the input to the recommendation model may include one or more portions of performance optimization insights generated by one or more other performance analysis model such as, but not limited to, performance ranks and performance diagnostics data.

As used herein, the term “spatial region” refers to a data entity that describes or is otherwise indicative of a physical environment or a location. For example, a spatial region may be a premises associated with one or more analytical units. Examples of spatial regions include, but not limited to, server storage locations, retail stores, medical facilities, or the like.

As used herein, the term “aggregated data set” refers to a data entity that describes a collection of one or more unit performance data. For example, aggregated data set may comprise unit performance data set for each of one or more analytical units that have been extracted from one or more client performance data and preprocessed. In some examples, aggregated data set may be leveraged to perform a predictive benchmarking task with respect to an analytical unit by comparing the predictive performance data set for the analytical with the aggregated data set.

As used herein, the term “virtual widget” refers to a visual element rendered or capable of being rendered within a digital interface. In some embodiments, the digital interface may include a graphical user interface, such as a smartphone interface or augmented reality interface. The virtual widget may be an interactive element or tool that exists within and is manipulable in a digital environment. Non-limiting examples of virtual widgets may include pop-ups, tiles, buttons, scroll bars, pages, virtual screens, checkboxes, or the like.

As used herein, the term “performance insight request indication” refers to any signals, data, instructions, messages, and/or or the like configured to trigger or otherwise initiate a predictive performance analysis process and/or otherwise configured to generate a predictive performance data set for one or more analytical units indicated via the performance insight request indication.

As used herein, the term “virtual widget selection indication” refers to any signals, data, instructions, messages, and/or the like configured to indicate a virtual widget selection (e.g., by a user). In some embodiments, predictive performance data set, and/or other information associated with the virtual widget corresponding to the virtual widget selection indication is rendered on a screen of a user device via a corresponding user interface or the virtual widget. For example, a user interface comprising one or more representations of a respective portion of a predictive performance data associated with the virtual widget may be rendered on a screen of the user device in response to the virtual widget selection indication. In some embodiments, the one or more representations may be rendered within the virtual widget, such as when the user device is in AR mode or otherwise an AR device.

As used herein, the term “access” refers to the ability to receive, retrieve, view, make available, make use of, or the like of a feature or data associated with a virtual widget or user interface.

### System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

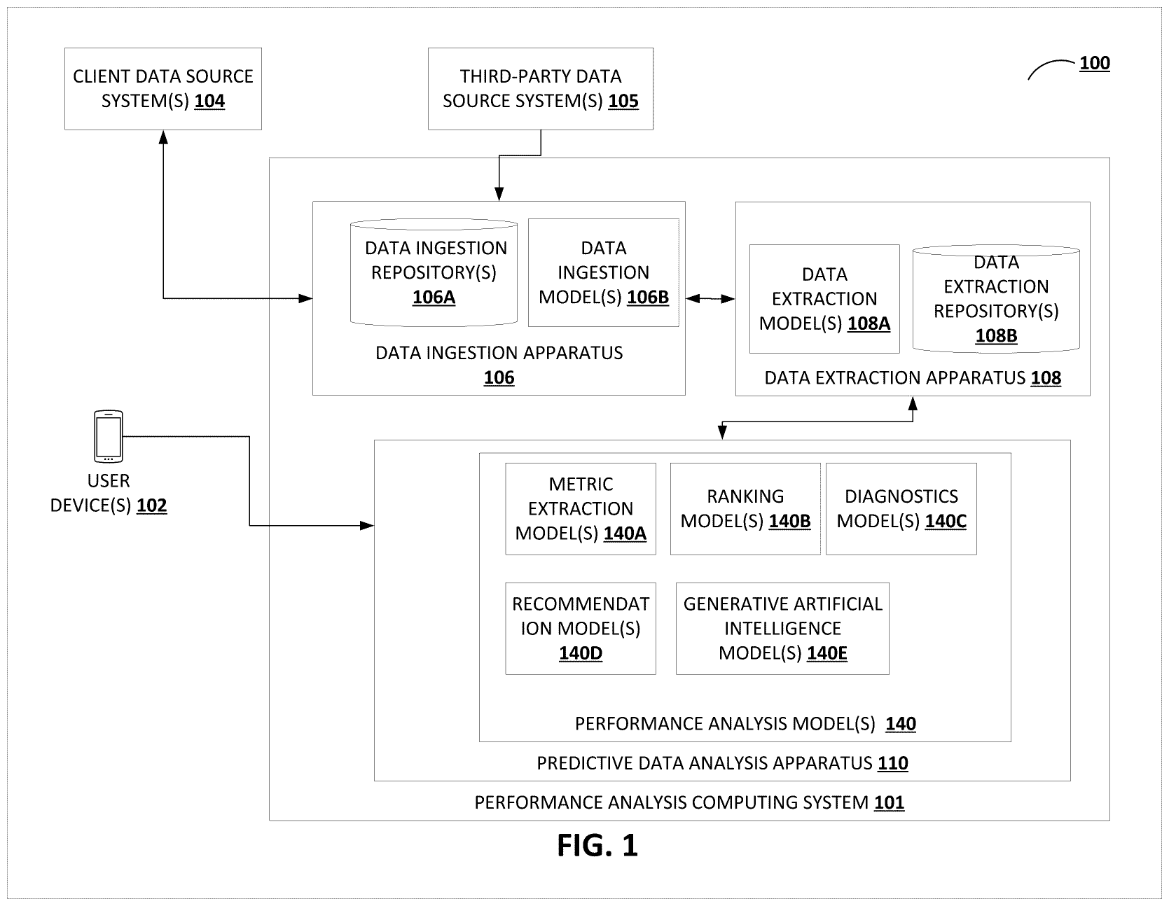

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

As shown in FIG. 1, the example system environment 100 includes a performance analysis computing system 101, one or more user devices 102, one or more client data source systems 104, and/or one or more third-party data source systems 105. The performance analysis computing system 101 may be in communication with one or more of the user device(s) 102, client data source system(s) 104, and/or third-party data source system(s) 105.

It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. For example, in some embodiments, the functions of one or more of the illustrated components in FIG. 1 may be performed by a single computing device or by multiple computing devices, which devices may be local or cloud based. It will be appreciated that the various functions performed by two or more of the performance analysis computing system 101, the user device(s) 102, the client data source system(s) 104, and/or the third-party data source system(s) 105 may be embodied by a single apparatus, subsystem, or system comprising one or more sets of computing hardware (e.g., processor(s) and memory) configured to perform various functions thereof.

In some embodiments, the performance analysis computing system 101 or portions thereof (e.g., one or more components of the performance analysis computing system 101) may be embodied by a user device 102. The performance analysis computing system 101 may be configured to provide a platform, such as a mobile application platform and/or a web application platform for access by a user. In this regard, the mobile application platform may be accessed by a user device 102 via an application installed in the user device 102. Further, the web application platform may be accessed by a user device 102 via a web browser, mobile browser application (e.g., a Wireless Application Protocol browser), and/or the like.

In some embodiments, a user device 102 is electronic computing device that may be used by a user for any of a variety of purposes including, but not limited to, one or more of sending and/or receiving signals, storing data, displaying data, viewing data, or initiating predictive performance analysis computing task(s). For example, the user device 102 may be capable of, but not limited to, one or more of displaying renderable virtual widgets on the screen of the user device 102, receiving user input that triggers predictive performance data analysis computing task(s), determining and/or receiving location data that triggers dynamic update of a screen of the user device 102 and/or information displayed on the screen of the user device 102, or delivering representations of a predictive performance data set (or portions thereof) to a user.

A user device 102 may include computer hardware and/or software configured to perform one or more functionalities associated with the user device 102. In some embodiments, the user device 102 may be a mobile device. The mobile device may be a user device that is capable of being held and transported by a user. Example mobile devices include, but not limited to, smart phones, tablet computers, laptop computers, wearables, laptop computers, or the like. Alternatively or additionally, the user device 102 may be an augmented reality (AR) device. The AR device may be a user device that is capable of providing interactive virtual adaptation of a real-world environment. Example AR devices include, but not limited to, AR smart glasses, AR headsets, AR smart phones, AR tablets, or the like. In some embodiments, the user device may include one or more sensors, systems, or the like configured for determining location data or otherwise the location of the user device. For example, the user device may include a global position system (GPS) and/or other sensor systems or devices configured to determine the absolute location data for the user device 102.

The performance analysis computing system 101 may include a data ingestion apparatus 106, a data extraction apparatus 108, and/or a predictive data analysis apparatus 110. In the illustrated embodiment of FIG. 1, the data ingestion apparatus 106 includes one or more data ingestion models 106B configured to facilitate performance of one or more functions of the data ingestion apparatus 106. As further shown in FIG. 1, the data extraction apparatus 108 includes one or more data extraction models 108A configured to facilitate performance of one or more functions of the data extraction apparatus 108 and the predictive data analysis apparatus 110 includes one or more performance analysis models 140 configured to facilitate performance of one or more functions of the predictive data analysis apparatus 110.

In some embodiments, the functions of one or more of the illustrated components of the performance analysis computing system 101 may be performed by a single computing device or by multiple computing devices, which devices may be local or cloud based. It will be appreciated that the various functions performed by two or more of the data ingestion apparatus 106, data extraction apparatus 108, and/or predictive data analysis apparatus 110 may be performed by a single apparatus, subsystem, or system. For example, two or more of the data ingestion apparatus 106, data extraction apparatus 108, and/or predictive data analysis apparatus 110 may be embodied by a single apparatus, subsystem, or system comprising one or more sets of computing hardware (e.g., processor(s) and memory) configured to perform various functions thereof.

The various functions of the performance analysis computing system 101 and system environment 100 may be performed by other arrangements of one or more computing devices and/or computing systems without departing from the scope of the present disclosure. In some embodiments, a computing system may comprise one or more computing devices (e.g., server(s)).

The various components illustrated in the performance analysis computing system 101 and system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the components depicted in FIG. 1 as being included in the performance analysis computing system 101, although not required to be an integral system, may be connected via one or more networks. In some embodiments, one or more APIs may be leveraged to communicate with and/or facilitate communication between one or more of the components illustrated in the performance analysis computing system 101 and system environment 100.

### Example System Operation

The performance analysis computing system 101 is configured to ingest performance data of various data types and/or data sources at a client entity level and/or at sub-increment levels of the client entity, generate holistic predictive performance data sets at the various levels, and dynamically provide the predictive performance data sets to users in a single dynamic platform via renderable virtual widgets. The performance analysis computing system 101, using one or more trained performance analysis models and/or other models as described herein, may be configured to assess current performance of analytical units, and generate predictive performance data sets for the analytical units. The predictive performance data sets may include one or more of performance ranks for analytical units (e.g., to facilitate comparison among similar analytical units, to facilitate a reward system for analytical units, to serve as an incentive mechanism for analytical units, and/or the like); performance improvement recommendations (e.g., including faults/issues, root cause for resolving faults/issues, areas of opportunities for improvement, corrective actions, training recommendations, training data, re-configuration data, or the like, resource allocation recommendations, resource assignment recommendations, operating plan recommendations); or the like.

The predictive performance data set for an analytical unit that is provided to a user (e.g., via virtual widgets on a screen of a user device associated with the user) may be tailored to the user according to the various embodiments described herein. For example, the predictive data set and user data (e.g., user identifier, user role, user permissions data, or the like) associated with the user may be applied to a performance analysis model that is configured to extract portions of the predictive data set for the analytical unit that is relevant to the user based on the user data. In some embodiments, the predictive performance data sets may be generated based at least in part on user data associated with the user whom the predictive performance data set will be provided, where the predictive performance data set generated for the analytical unit with respect to a first user may be different from the predictive performance data set generated for the analytical unit with respect to a second user.

In this regard, embodiments of the present disclosure improve the capability of the apparatus(es) disclosed herein to conduct performance analysis by receiving client entity data and providing, using one or more performance analysis models, predictive performance data sets to one or more users, where each predictive performance data set provided for a user comprise performance insights that are relevant to the respective user. For example, a network engineer may receive performance insights that include network efficiency improvement recommendations while the site manager may receive performance insights that include staffing recommendations. As another example, a first user or system associated with core temperature monitoring of a computer system may receive predictive performance data set relevant to optimizing the core temperature of the analytical unit while a second user or system associated with storage space capacity may receive predictive performance data set relevant to optimizing the storage space of the analytical unit, in some instances based on the same initial unit performance data. In some embodiments, one user may receive predictive performance data sets and/or virtual widgets associated with a client entity and/or a plurality of analytical units. In this regard, embodiments of the present disclosure provide various technical advantages including dynamically and automatically parsing client performance data without the need for manual identification and/or hardcoding of relevant portions of the client performance data and/or relevant performance insights to provide to the user. This flexible, dynamically adjustable system enables the computing system to receive unknown and/or disparate input data to generate more accurate predictive performance data and to improve the performance of the trained performance analysis models.

Furthermore, by providing holistic and reliable predictive performance data sets that are accessible to users via a single platform, embodiments of the present disclosure obviate the need for users to consult multiple platforms to access various data for performance assessment. This, in turn, reduces network traffic and computing resource usage. Further, by providing holistic and reliable predictive performance data sets as described above, embodiments of the present disclosure facilitate performance improvement of analytical units and overall performance of associated client entity.

The performance analysis computing system 101 may leverage the data ingestion apparatus 106 to ingest client performance data comprising analytical unit performance data of various data types and/or originating from various data sources to facilitate predictive performance analysis as described herein. The data extraction apparatus 108 may comprise one or more computing devices embodied in hardware, software, firmware and/or a combination thereof configured to facilitate and/or perform one or more functions associated with predictive performance analysis techniques described herein configured to generate predictive performance data sets for an analytical unit. The data ingestion apparatus 106 may be configured to receive performance data for a client entity at various levels of granularity with respect to the client entity. For example, the data ingestion apparatus 106 may be configured to receive performance data at the client level (e.g., client performance data) and/or at sub-increment levels of the client entity (e.g., unit performance data for one or more analytical units associated with the client entity, which analytical units may be associated with various hierarchical levels).

In some embodiments, a client entity is an entity that includes one or more analytical units. A client entity may be configured to generate and/or provide one or more outputs (e.g., products, services, functionalities, or the like). For example, a client entity may include one or more analytical units configured to perform individual and/or coordinated functions, tasks, or activities associated with the client entity to generate the one or more outputs. A client entity may include a network, system, or other logical arrangement of the one or more analytical units. Client performance data for a client entity may be collected for a client entity from one or more data source.

The client performance data for a client entity may include data generated by the client entity and/or data generated about the client entity. Such data may include unit performance data for analytical units associated with the client entity. For example, where the client entity is a mobile device, the client performance data may include unit performance data for the battery of the mobile device, unit performance data for the processor of the mobile device, unit performance data for memory devices of the mobile device, unit performance data for the operating system of the mobile device, or the like. As another example, where the client entity is a product and service provider such as a retail entity, the client performance data may include unit performance data for sales agents of the product and service provider, unit performance data for product managers of the product and service provider, or the like. As yet another example, where the client entity is a distributed server system, the client performance data may include unit performance data for individual servers of the distributed server system, unit performance data for individual processors of each server, unit performance data for individual memory devices of each server, or the like. In this regard, the client performance data for a client entity may be leveraged to generate predictive performance data sets for analytical units associated with the client entity in accordance with techniques described herein.

In some embodiments, client performance data may further include data related to a domain associated with the client entity. For example, where the client entity is a mobile device, the client performance data may include data about or related to other similar mobile devices (e.g., other mobile devices with a similar device characteristics such as mobile device type, mobile device processor type, mobile device operating system type, mobile device manufacturer, or the like). As another example, where the client entity is a product and/or service provider such as a retail entity (e.g., retail store location of a company, a company that provides retail goods, or the like) the client performance data may include data about or related to other retail entities in the same product and/or service industry as the retail entity (e.g., other retail entities with similar characteristics such as corporation size, products sold, geographical area, market share, market trend, and/or the like). As yet another example, where the client entity is a distributed server system, the client performance data may include data about or related to other similar distributed server systems.

In some embodiments, the client performance data may include output data for the client entity, which may include unit output data for each of one or more analytical units of the client entity. As used herein, unit output data describes data related to transactions associated with an analytical unit (e.g., over a specified time period). By way of non-limiting example, in a product and service provider domain, an example of output data is sales transaction data for a sales agent such as quantity of products sold by the analytical unit, the price of each product sold by the sales agent during the specified time period, transaction types, sales type code, sales type description, cooling off period, excess amount, product care RRP, sell tax, sell GP, gross profits, net profit, and/or the like. Alternatively or additionally, in some embodiments, the client performance data may include capacity data for the client entity, which may include unit capacity data for each of one or more analytical units of the client entity. As used herein, unit capacity data may describe estimated throughput for an analytical unit (e.g., over a specified time period). For example, an example of capacity data is sales opportunity data for a sales agent such as the number of opportunities for the sales agent to make a sale over a specified period of time).

Alternatively or additionally, in some embodiments, the client performance data may include claims data for the client entity, which may include unit claims data for each of one or more analytical units of the client entity. As used herein, unit claims data may describe data related to post transactions events associated with an analytical unit. For example, where the analytical unit is a sales agent, the claims data may include the number of claims filed to return a product or service sold by the sales agent over a specified time period. Alternatively or additionally, in some embodiments, the client performance data may include historical performance data for the client entity, which may include unit historical performance data for each of one or more analytical units of the client entity. Alternatively or additionally, in some embodiments, the client performance data may include performance target data for the client entity, which may include unit performance target data for each of one or more analytical units of the client entity.

Alternatively or additionally, in some embodiments, the client performance data may include domain data for the client entity. As used herein, domain data may describe data associated with client entities having particular characteristics. For example, where the analytical unit is a sales agent, domain data may include market trend in the corresponding industry. Alternatively or additionally, in some embodiments, the client performance data may include policy data for the client entity. As user herein, policy data may include procedures, rules, regulations, principles of action, or the like adopted by a client entity. Alternatively or additionally, the client performance data may include third-party data. As user herein, third-party data may describe data about third-party entities that may engage in a transaction with a client entity (e.g., via analytical units of the client entity) or have previously engage in a transaction with the client entity. For example, in a product and/or service provider domain, third-party data may include data about a current customer, previous customer, or potential customer of a client entity. Third-party data may include linked third-party data with respect to an analytical unit. As used herein, linked-third-party data may describe third-party data of a third-party entity that is associated with an analytical unit such as, for example, a previous customer or current customer of an analytical unit. It would be appreciated that in some embodiments, the client performance data may include other types of client performance data and/or may not include one or more of the aforementioned client performance data.

In some embodiments, an analytical unit is an entity for which predictive performance analysis may be performed to generate a predictive performance data set to, for example, improve the performance of the analytical unit and/or client entity associated with the analytical unit. In some embodiments, an analytical unit may be associated with one or more real-world and/or virtual tasks for which the predictive performance analysis may be performed. For example, an analytical unit may be configured, trained, and/or the like to, individually and/or collectively with one or more other analytical units, perform one or more tasks, operations, or the like, to generate one or more outputs (e.g., products, services, functionalities, or the like) associated with the client entity. Alternatively or additionally, an analytical unit may be configured, trained, and/or the like to monitor and/or track the results, effects, successes, of the one or more outputs and/or other analytical units (e.g., via receiving, inputting, and analyzing unit performance data after generation of a first set of predictive performance data and/or renderable virtual widget(s). Data associated with the outputs and/or the tasks may be collected, with or without other data, to facilitate the predictive performance analysis.

In some embodiments, the data ingestion apparatus 106 may be configured to obtain client performance data for a client entity from one or more data sources. For example, the data ingestion apparatus 106 may extract and/or receive client performance data for a client entity from one or more client data source systems 104 associated with the client entity and/or one or more third-party data source systems 105. A client data source system 104 may store client performance data (or a portion thereof) for associated client entity. Alternatively or additionally, a third-party data source system 105 may store client performance data (or a portion thereof) for one or more client entities.

In some embodiments, the data ingestion apparatus 106 includes one or more data ingestion models 106B that is leveraged by the data ingestion apparatus 106 to facilitate collecting, gathering, aggregating and/or otherwise obtaining client performance data from client data source systems 104 and/or third-party data source system(s) 105. In some embodiments, the data ingestion apparatus 106, utilizing at least one data ingestion model 106B, may leverage one or more extraction techniques (e.g., standard query language (SQL), optical character recognition (OCR), image recognition, web scraping, or the like) to identify and extract client performance data from a client data source system 104 and/or third-party data source system 105. For example, at least one data ingestion model 106B may utilize OCR extraction techniques, image recognition techniques, text recognition techniques or other extraction techniques to extract client data from different data structures (structured data, unstructured data, semi-structured data, or the like) and/or different document formats, (e.g., portable document formats (PDF), video files, audio files, images, spread sheets, power point documents, DOCX files, hyper-text markup language (HTML), extensible markup language (XML), or the like). The data ingestion apparatus 106 may utilize APIs, webhooks, and/or other mechanisms to facilitate extraction of the client performance data from a client data source system 104 and/or third-party data source system 105.

In some embodiments, the data ingestion apparatus 106, is configured to perform one or more data preprocessing operations on the client performance data obtained from a client data source system 104 and/or third-party data source system 105 using at least one data ingestion model to, for example, improve the quality of the client performance data and/or transform the client performance data into a form that is suitable for and understandable by downstream processes of the predictive performance analysis techniques described herein. In some embodiments, at least one of the data ingestion models 106B may be leveraged to perform the preprocessing operations. For example, the data ingestion apparatus 106 may apply client performance data obtained from a client data source system 104 and/or third-party data source system 105 to the data ingestion model 106B to output preprocessed client performance data. The data ingestion model 106B may trained, configured, or the like to receive client performance data as input, preprocess the client performance data and output corresponding preprocessed client performance data.

In some embodiments, a data ingestion model 106B may be trained on training data associated with the client entity and/or training data associated with the corresponding domain. For example, the data ingestion model 106B may be trained using training data that comprises historical client performance data associated with the client entity and/or data associated with the domain. In some embodiments, the data ingestion model 106B may be trained on generic training data. In some embodiments, the data ingestion model 106B may be a pre-trained data ingestion model 106B.

In some embodiments, the data preprocessing operations performed on the on client performance data include one or more of data cleaning (e.g., detecting and removing outliers, inaccurate data, duplicate data, or the like), data transformation (e.g., structuring unstructured client performance data, scaling, normalizing, and/or standardizing the client performance data, or the like), feature engineering (e.g., organization the client performance data, extracting relevant features for predictive performance analysis tasks, or the like) dimensionality reduction (e.g., reducing the size of the client performance data into a low-dimensional space, or the like). The data preprocessing operations may include transforming one or more portions of the client performance data into formats, types, or other domains that may be compatible with the downstream models and/or other portions of the client performance data (e.g., via mapping algorithm comprising associations between the respective formats, types, or other domains).

As shown in FIG. 1, the data ingestion apparatus 106 may include one or more data ingestion repositories 106A. The one or more data ingestion repositories 106A may be configured to store the client performance data locally. Alternatively or additionally, in some embodiments, the data extraction apparatus 108 is configured to transmit the unit performance data to, for example, a cloud storage server or other server or other suitable remote storage location.

In some embodiments a data ingestion repository 106A may include one or more storage units, such as multiple distributed storage units that are connected through a computer network. In some embodiments, each storage unit may store client performance data associated with a respective client entity and/or unit performance data for analytical units associated with the client entity. In some embodiments, each storage unit may store unit performance data associated with an analytical unit. In some embodiments, each storage unit in the data ingestion repositories 106A may include one or more non-volatile storage or memory media including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

In some embodiments, the performance analysis computing system 101 includes a data extraction apparatus 108. In some embodiments, the data extraction apparatus 108 may comprise one or more computing devices embodied in hardware, software, firmware and/or a combination thereof configured to facilitate and/or perform one or more functions associated with predictive performance analysis techniques described herein configured to generate predictive performance data sets for analytical units. For example, the data extraction apparatus 108 may facilitate and/or perform extracting, collecting, preprocessing, storing, and/or updating of unit performance data that is leveraged to generate predictive performance data sets for the analytical units in accordance with techniques described herein.

In some embodiments, the data extraction apparatus 108 is configured to receive client performance data associated with a client entity from the data ingesting apparatus 106, identify unit performance data for one or more analytical units associated with the client entity based on analytical unit identifiers and/or other data that may be leveraged to identify unit performance data (e.g., location data, analytical unit profiles, or the like), and extract the identified unit performance data. In some embodiments, an analytical unit identifier includes one or more items of data by which an analytical unit may be uniquely identified from other analytical units. For example, an analytical unit identifier may comprise ASCII text, a pointer, a memory address, and/or other data that uniquely identifies a particular analytical unit. In an example embodiment, the analytical unit identifier includes a name of the analytical unit.

The data extraction apparatus 108 may include one or more data extraction models 108A leveraged by the data extraction apparatus 108 to extract unit performance data from client performance data received from the data ingestion apparatus 106. For example, the data extraction apparatus 108 may be configured to apply the client performance data to one or more data extraction models 108A to extract unit performance data for one or more analytical units of the client entity associated with the client performance data. The data extraction apparatus 108 and/or data extraction model(s) 108A may utilize one or more extraction algorithms to identify and extract the unit performance data for the one or more analytical units.

In some embodiments, a data extraction model 108A is trained, configured, or the like to extract unit performance data for analytical units from client performance data using an association-based extraction algorithm. For example, the data extraction model 108A may utilize an association-based extraction algorithm to identify relationships and/or patterns in client performance data and identify unit performance data for analytical units based on the relationships and/or patterns. Alternatively or additionally, in some embodiments, a data extraction model 108A may be trained, configured, or the like extract unit performance data for analytical units from client performance data using a classification-based extraction algorithm. For example, the data extraction model 108A may utilize a classification-based algorithm to segment the client performance data into groups, where each group corresponds to unit performance data for a respective analytical unit. Alternatively or additionally, in some embodiments, a data extraction model 108A may be trained, configured, or the like extract unit performance data for analytical units from client performance data using a clustering-based extraction algorithm. For example, the data extraction model 108A may utilize a clustering-based algorithm to assign the client performance data into clusters, where each cluster corresponds to unit performance data for a respective analytical unit. Alternatively or additionally, in some embodiments, a data extraction model 108A is trained, configured, or the like extract unit performance data for analytical units from client performance data using a regression-based extraction algorithm. It would be appreciated that the data extraction apparatus 108 and/or a data extraction model 108A may leverage other extraction techniques to extract unit performance data from client performance data.

In some embodiments, the data extraction apparatus 108 may be configured to perform one or more data preprocessing operations on the extracted unit performance data such as the data preprocessing operations described above with respect to the data ingestion apparatus 106. In some embodiments, the data extraction apparatus 108 may be configured to perform the data preprocessing operations in addition to the data preprocessing operations performed on the client performance data by the data ingestion apparatus. In some embodiments, the data ingestion apparatus 106 may perform data preprocessing operations on the client performance data such that there may not be a need to perform data preprocessing operations on the unit performance data extracted from the client performance data. In some embodiments, the data ingestion apparatus 106 may not perform data preprocessing operations on the client performance data and the data extraction process may be configured to perform data preprocessing operations on the extracted unit performance data.

In some embodiments, the data extraction apparatus 108 is configured to store the preprocessed unit performance data locally. Alternatively or additionally, in some embodiments, the data extraction apparatus 108 is configured to transmit the preprocessed unit performance data to, for example, a cloud storage server or other server or other suitable remote storage location. In the embodiment depicted in FIG. 1, the data extraction apparatus 108 includes one or more data extraction repositories 108B. The data extraction apparatus 108 may store preprocessed unit performance data in the one or more data extraction repositories 108B. In some embodiments a data extraction repository 108B may include one or more storage units, such as multiple distributed storage units that are connected through a computer network. In some embodiments, each storage unit may store unit performance data for analytical units associated with a client entity. In some embodiments, each storage unit may store unit performance data associated with an analytical unit. In some embodiments, each storage unit in the data extraction repositories 108B may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As shown in FIG. 1, the performance analysis computing system 101 includes a predictive data analysis apparatus 110. The predictive data analysis apparatus 110 may comprise one or more computing devices embodied in hardware, software, firmware and/or a combination thereof configured to facilitate and/or perform one or more functions associated with predictive performance analysis techniques described herein configured to generate predictive performance data sets for an analytical unit, a set of analytical units or a client entity. The predictive data analysis apparatus 110 may include one or more performance analysis model(s) 140 that are leveraged by the predictive data analysis apparatus 110 to generate predictive performance data sets for analytical units.

In some embodiments, the predictive data analysis apparatus 110 is configured to receive unit performance data from the data extraction apparatus 108, apply the unit performance data to one or more of the trained performance analysis model(s) 140 to generate a predictive performance data set for the analytical unit, generate one or more representations of at least a portion of the predictive performance data set, generate one or more renderable virtual widgets comprising the one or more representations, and display the one or more renderable virtual widgets on a screen of a user device 102.

Unit performance data may include data generated by the analytical unit and/or data generated about the analytical unit. The unit performance data, for example, may include one or more of unit output data that describes data related to transactions associated with the analytical unit over a specified time period (e.g., number of sales made by a sales agent over a specified time period and related data, or the like); unit capacity data for an analytical unit that describes estimated throughput for the analytical unit (e.g., opportunity data in a product and/or service provider domain example); unit claims data that describes data related to certain post transaction events associated with the client entity (e.g., number of return claims and related data in a product and/or service provider domain example); unit historical performance data for the analytical unit; unit performance target data for the analytical unit; domain data that describes data associated with client entities and/or analytical units having particular characteristics in common, such as, for example, market trend data; policy data that describe procedures, rules, regulations, principles of action, or the like adopted by a client entity associated with the analytical unit; third-party data that describe data about third-party entities that may engage in a transaction with a client entity (e.g., via analytical units of the client entity) or have previously engage in a transaction with the client entity including linked third-party data; metadata for the analytical unit such as location data for the analytical unit, time of day, and/or the like. In a product and/or service provide domain, for example, location data for the analytical unit may include site id, site name, store number, movex, department, or the like.

It would be appreciated that the unit performance data may include different data based on the domain. For example, in a product and/or service domain, the unit performance data may, alternatively or additionally, include one or more of product information (e.g., product category, product hierarchy, brand, product code, SAP article id, or the like), insurance information (e.g., coverage date, coverage type, terms and conditions, term, premium, insurance code, claim date, loss type, or the like), sales data (e.g., offer price, bookout date, quantity, unit sell price, transaction type, sale type code, sale type description, cooling off period, excess amount, product care RRP, sell tac, sell gross profit, gross profit EX-GST, USP-NET-C, CM-Key, or the like), sales agent information (e.g., sales agent name, sales agent ID, or the like). In some embodiments, unit performance data may include or be packaged with client performance data and/or client performance data may be used to generate one or more sets of unit performance data, whether preprocessed to extract analytical unit specific data or as part of a single larger data set. In some embodiments, the one or more models disclosed herein may take a combination of analytical unit specific data and other data (e.g., client-wide client performance data, aggregated data, linked third party data, or any other data disclosed herein) as inputs to generate the predictive performance data set. As described herein, unit performance data may include performance insights. For example, in a particular domain, such as but not limited to insurance sales domain, unit performance data may be analyzed to generate customer behavior metrics such as price sensitivity (e.g., willingness to purchase at certain price points), product knowledge (e.g., understanding of the product during a sales process by, for example, observing that a customer cancels within a certain number of days), or the like. As another example, unit performance data may be analyzed to determine whether a sales agent, store, or other analytical unit meets logistics service levels, determine whether a sales agent, store, or other analytical unit tend to sell to customers who cancel within a certain time period (e.g., selling to customers who cancel quickly), detect when a sales agent, store, or other analytical unit is lagging in sales metrics relative to other sales agents, stores, or other analytical unit (e.g., relative to peers).

It would be appreciated that in some embodiments, unit performance data may be related to non-insurance programs such as logistics, fraud, or the like. In such embodiments, the unit performance data and/or a portion of the predictive performance data set for the corresponding analytical unit may include shipment data, data relating receipts at a warehouse, asset condition data, or the like.

In some embodiments, the predictive data analysis apparatus 110, based on the unit performance data and using one or more performance analysis models 140, may leverage one or more of a variety of techniques to generate the predictive performance data set for an analytical unit. Such techniques may include one or more of correlating and/or matching two or more portions of the unit performance data, aggregating two or more portions of the unit performance data, comparing two or more portions of the unit performance data, identifying relationships between portions of the unit performance data, identifying patterns in the unit performance data, identifying performance trends based on the unit performance data, identifying outliers in the unit performance data, generating and/or simulating what-if scenarios (e.g., Monte Carlo simulation, or the like), performing statistical analysis based on one or more portions of the unit performance data, performing regression analysis based on one or more portions of the unit performance data, performing time series analysis, performing behavior analysis, or the like.

In some embodiments, the predictive data analysis apparatus 110 may receive the unit performance data from the data extraction apparatus 108 in response to receiving a performance insight request indication from a user via a user device 102 associated with the user. The performance insight request indication may include at least one analytical unit identifier and/or other data that may be leveraged to identify an analytical unit. In response to receiving the performance insight request indication, the predictive data analysis apparatus 110 may transmit signals, data, or the like including the analytical unit identifier (and/or other data that may be leveraged to identify an analytical unit) to the data extraction apparatus 108 indicative of a request for unit performance data for the analytical unit associated with the analytical unit identifier (and/or other data that may be leveraged to identify an analytical unit).

Upon receiving the unit performance data, the predictive data analysis apparatus 110 may leverage at least one of the performance analysis model(s) 140 to generate a predictive performance data set for the analytical unit. For example, the predictive data analysis apparatus 110 may input the unit performance data for an analytical unit into a performance analysis model framework comprising at least one performance analysis model. The performance analysis models may be trained, individually and/or together, to analyze unit performance data associated with an analytical unit and generate a predictive performance data set based on the analysis.

In some embodiments, the predictive performance data set generated for an analytical unit may include performance insights for an analytical unit. In some embodiments, the performance insights include performance optimization insights such as, but not limited to, performance rank; performance diagnostics data (e.g., performance issues, root cause of performance issues, low performance contributing factors, high performance contributing factors, or the like); customized performance improvement recommendations (e.g., fine-tuning and/or training recommendations including training data, re-configuration data, resource allocation and/or re-allocation recommendations, corrective action recommendations, training engine, or the like); or the like. Additionally, in some embodiments, the performance insights include performance metrics insights such as, but not limited to, unit throughput data; unit capacity utilization data; behavior data; or the like. It will be appreciated that in some embodiments the predictive performance data sets may include other data and/or may not include one or mor of the aforementioned examples. In some embodiments, the performance insight request indication may include signals, data, or the like that indicates or otherwise dictates the predictive performance data set to generate for an analytical unit by the predictive data analysis apparatus 110. For example, the performance insight request indication may indicate a request for a particular predictive performance data set and/or information therein.

In some embodiments, a trained performance analysis model 140 is one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to generate or facilitate generation of predictive performance data sets and related predictions, data, and other outputs. A trained performance analysis model may include artificial intelligence algorithms and techniques, including machine learning. A trained performance analysis model may be configured, trained, and/or the like to generate a predictive performance data set for an analytical unit based on unit performance data for the analytical unit. For example, a trained performance analysis model may be configured, trained, and/or the like to receive unit performance data, analyze the unit performance data, and output predictive performance data set(s) based on the analysis of the unit performance data.

A trained performance analysis model may include one or more of any type of machine learning models including one or more supervised, unsupervised, semi-supervised, reinforcement learning models, and/or the like. In some examples, a trained performance analysis model of the one or more trained performance analysis models 140 include a generative artificial intelligence model, an artificial neutral network, or the like.

A trained performance analysis model 140, such as an artificial neutral network, may be configured to generate the predictive performance data sets or a portion thereof by recognizing patterns in the unit performance data set using machine learning algorithms. For example, in some embodiments, to generate the predictive performance data set for an analytical unit or a portion of the predictive performance data set for the analytical unit, the predictive data analysis apparatus 110 extracts one or more features from the unit performance data, formats the one or more features into multidimensional vectors, and inputs the multidimensional vector into the trained performance analysis model 140. For example, the predictive data analysis apparatus 110 may extract one or more features from the unit output data, unit capacity data, unity claims data, unit historical performance data, unit performance target data, and/or domain data that constitute the unit performance data and/or extract one or more features from unit through put data, unit capacity utilization data, behavior data, or the like previously generated by a performance analysis model 140.

The predictive data analysis apparatus 110 may then generate multidimensional vectors based on the extracted features (e.g., format the extracted features into multidimensional vectors) for analysis by a trained performance analysis model 140. The performance analysis model 140 may be trained on a training data set, which may include labeled training data. The training data set, for example, may include the target output (e.g., predictive performance data set or portions thereof) that the performance analysis model 140 is being trained to predict along with extracted features from historical unit performance data.

In some examples, a trained performance analysis model may include multiple models configured to perform one or more stages of a performance analysis. For example, a trained performance analysis model may include (i) a first model configured to receive unit performance data and process the unit performance data to identify, extract, and/or generate performance metrics insights and (ii) a second model configured to receive the performance metrics insights and analyze the performance metrics insights to generate a predictive performance data set. For example, in some embodiments, the predictive data analysis apparatus 110 may include one or more performance analysis models including, but not limited to, one or more of metric extraction model(s) 140A, ranking model(s) 140B, recommendation model(s) 140D, or generative artificial intelligence model(s) 140E.

In this regard, in some embodiments, the predictive data analysis apparatus 110 may generate a predictive performance data set for an analytical unit using a multi-stage performance analysis approach. For example, in some embodiments, the predictive data analysis apparatus 110 may be configured to apply the unit performance data to a metric extraction model 140A to identify and/or generate performance metrics insights for the analytical unit and apply the performance metrics insights to one or more other performance analysis models 140 to generate performance optimization insights such as performance rank, performance diagnostic data, performance improvement recommendations, or the like. For example, the predictive data analysis apparatus 110 may apply the performance metrics insights to one or more ranking models 140B to generate performance rank(s) for the analytical unit, apply the performance metrics insights to one or more diagnostics model 140C to generate performance diagnostics data for the analytical unit, apply the performance metrics insights to one or more recommendation models 140D to generate performance improvement recommendations for the analytical unit, and/or apply one or more other performance analysis models to generate one or more other performance optimization insights for the analytical unit. In some embodiments, the predictive data analysis apparatus 110 may generate the performance optimization insights or a portion thereof using a generative artificial intelligence models 140E. For example, the predictive data analysis apparatus 110 may apply the performance metrics insights to at least one generative artificial intelligence model 140E to generate one or more of the performance rank(s), performance diagnostics data, or performance improvement recommendation(s).

The predictive data analysis apparatus 110, using the performance analysis models, may leverage various portions of the unit performance data and/or techniques to generate various portions of the predictive performance data set. For example, at least one performance analysis model may be configured to leverage a dynamic scoring algorithm to generate a portion of the predictive performance data set corresponding to areas of opportunities for the analytical unit or associated client entity (e.g., identified opportunities to improve output). In some embodiments, the dynamic scoring algorithm includes assigning weights to performance targets (e.g., key performance indicators) and using the weighted performance targets to identify areas of opportunities. As another example, at least one performance analysis model may be configured to leverage domain data (e.g., industry data in products and sales domain example) to generate benchmarking data. For example, in some embodiments, generating the predictive performance data set for an analytical unit may include generating aggregated data set from one or more analytical units and comparing the unit performance data for the analytical unit to the aggregated data set. For example, the aggregated data set may comprise unit performance data associated with one or more second analytical units. Comparing the predictive performance data set to the aggregated data set may comprise identifying matching portions of the predictive performance data set and the aggregated data set and comparing the matching portions.

The performance analysis models may be configured to analyze the various portions of the unit performance data for analytical unit, individually or collectively with one or more other portions of the unit performance data, to generate the predictive performance data set for the analytical unit. For example, in some embodiments, a portion of the unit performance data for an analytical unit may include data associated with a third-party entity (e.g., a third-party entity, such as one or more third party analytical units, which may be linked with the analytical unit, linked with other analytical units of the client entity, linked with analytical units of other client entities, or not linked with any client entity). In some embodiments, one or more performance analysis models may be leveraged to analyze the third-party entity data to generate predictive performance data associated with the third party-entity. In some embodiments, the third-party entity data and/or predictive performance data associated with the third-party entity may be added to the set of unit performance data for the analytical unit or otherwise used alone or in combination with other unit performance data to generate predictive performance data sets for the analytical unit.

In such embodiments, one or more performance analysis models may be leveraged to analyze the third-party entity data to generate behavior data that is then analyzed along with one or more other portions of the unit performance data for the analytical unit to generate at least a portion of the predictive performance data set for the analytical unit. Such portion of the predictive performance data set that is generated based at least in part on the behavior data may include performance improvement recommendations, such as opportunities to increase throughput of the analytical unit, or the like. In some embodiments, this may include predicting linked units that are likely to increase throughput of the analytical unit if linked with the analytical unit based on the behavior data associated with the third-party entity. For example, analysis of the historical performance data for an analytical unit along with behavior data associated with candidate third-party entities may be leveraged to identify matching third-party entities with respect to increasing throughput of the analytical unit. The behavior data associated with the candidate third-party entities, for example, may be compared to behavior data associated with linked third-party entities that are deemed matching third-party entities to identify additional matching third-party entities from the candidate third-party-entities (e.g., matching third-party entities sharing similar behavior data and/or similar metadata is indicative of a compatibility with the analytical unit(s)). For example, predictive performance data sets may be generated at least in part by comparing the third-party entity data associated with the analyzed analytical unit (e.g., third party computing systems or users interacting with the analytical unit) with third party entity data associated with other analytical units. For example, where the analytical unit is a sales agent, one or more performance analysis models may be configured to analyze data associated with one or more customers of the client entity or potential customers to generate sales leads for the sales agent by predicting the customers that are likely to yield successful transactions if engaged by the sales agent.

As another example, a portion of the unit performance data may include output data (e.g., processing data for a processor, sales data for a sales agent, or the like), product data (e.g., product category, product code, and/or the like), location data for the analytical unit (e.g., location identifier, or the like), and/or analytical unit identification data (e.g., analytical unit identifier, or the like) that may be analyzed by one or more performance analysis models to generate at least a portion of the predictive performance data set for the analytical unit.

Further, in some embodiments, one or more performance analysis models may be leveraged to generate at least a portion of the predictive performance data set for the analytical unit by comparing the unit performance data for the analytical unit with unit performance data for other analytical units of the client entity associated with the analytical unit and/or comparing unit performance data for the analytical unit with unit performance data for other analytical units of other client entities. For example, a portion of the predictive performance data set for an analytical unit may include performance ranks for the analytical unit, where the performance ranks may be generated by comparing, using one or more performance analysis models, unit performance data for the analytical unit with unit performance data for other analytical units of the client entity associated with the analytical unit and/or comparing unit performance data for the analytical unit with unit performance data for other analytical units of other client entities. The performance ranks or other comparative predictive performance data may include a plurality of performance types (e.g., performance categories) with one or more predictive performance data sets associated with each to granularize the model output and generate specific predictive performance data and/or renderable virtual widgets for each performance type.

The predictive data analysis apparatus 110 may generate one or more representations of at least a portion of the predictive performance data set generated for an analytical. As used herein, representation may refer to a data entity that describes a visual presentation of data (e.g., predictive performance data set) or a portion thereof on a screen of a user device and in a particular form. For example, the predictive data analysis apparatus 110 may generate one or more of textual representations (e.g., natural language text), graphical representations, pictorial representations (e.g., images), video representations, or the like of the predictive performance data set for an analytical unit or group of analytical units. In some embodiments, the predictive data analysis apparatus 110 may leverage one or more generative artificial intelligence models 140E to generate at least one or more of the representations. For example, the predictive data analysis apparatus 110 may leverage a generative artificial intelligence model to generate a natural language summary (e.g., a narrative) of the predictive performance data set or portions thereof.

The predictive data analysis apparatus 110 may be configured to generate one or more widgets comprising the one or more representations. In some embodiments, one or more widget building algorithms may be leveraged to generate the virtual widgets. In some embodiments, this may include describing or otherwise defining the metadata for the respective virtual widget, such as layout (e.g., XML layout, or the like), update frequency, class, widget behavior, widget attributes, or the like. Alternatively or additionally, in some embodiments, generative artificial intelligence models 140E may be configured to generate the virtual widgets. For example, the predictive data analysis apparatus 110 may generate a prompt (or other input data) and provide the prompt to a generative artificial intelligence model 140E. The prompt may include data that describes a request to generate a particular type of representation for the predictive performance data set or a portion thereof and/or a request for a virtual widget comprising the particular type of representation. For example, the prompt may include a request for a virtual widget comprising a graphical representation of one or more portions of the predictive performance data set, a request for a virtual widget comprising a natural language summary of the predictive performance data set or a portion thereof, or the like. In some embodiments, the predictive data analysis apparatus 110 may determine the representation types based on the performance insight request indication. For example, the performance insight request indication may include the representation types. In some embodiments, the predictive data analysis apparatus 110 may leverage other techniques and/or other models to generate the representations and/or virtual widgets.

The predictive data analysis apparatus 110 may be configured to automatically display the renderable virtual widgets comprising the one or more representation on a screen of a user device. In some embodiments, the predictive data analysis apparatus 110 may display one or more of the renderable virtual widgets in response to receiving signals, data, or the like via the user device indicative of a request to display the corresponding virtual widgets. In some embodiments, the predictive data analysis apparatus 110 may be configured to dynamically update the one or more representations in a virtual widget in response to signals, data, and/or the like indicative or a request to change the representation type (e.g., from a graphical representation to a bar chart representation, from natural language text representation to a graphical representation, or the like). In some embodiments, a virtual widget may be associated with a security mechanism. For example, in virtual widget may require user authorization to provide access to the information in the virtual widget.

In some embodiments, the predictive data analysis apparatus 110 is configured to automatically update the virtual widgets displayed on the screen of a user device in response to one or more signals, data, or the like. For example, in some embodiments, the predictive data analysis apparatus 110 is configured to detect a location within a spatial region (e.g., premises such as a retail stores, or the like) via the screen of the user device. In this regard, the user device may be an AR device such as an AR smart phones, AR headset, AR glasses, or the like. The predictive data analysis apparatus 110 may be configured display a virtual widget that comprises representations of predictive performance data set for one or more analytical units associated with the detected location on the screen of the user device (e.g., the AR screen). The predictive data analysis apparatus 110 may be configured to change the virtual widget displayed on the AR screen to a second virtual widget corresponding to a second location in response to detecting the second location via the AR screen. The second virtual widget may comprise representations of predictive performance data set for one or more analytical units associated with the second location. In this regard, the predictive data analysis apparatus 110 may be configured to cause automatic update of virtual widgets displayed on the AR screen of the user device (e.g., AR device) based on the location in the field of view of the AR device.

In some embodiments, the predictive data analysis apparatus 110 may be configured to generate an alert in response to determining that the unit performance data for the analytical unit fails to satisfy one or more performance targets. The alert may be signals, messages, warnings, cautions, or the like generated by a performance analysis computing system. The alert may be indicative of an error or problem, such as a low performance, abnormality, issue, or the like associated with the analytical unit as determined by the predictive data analysis apparatus 110. In some embodiments, generating the alert comprises displaying a visual indicator via the one or more virtual widgets.

As describe above, in some embodiments, the predictive performance data set generated for an analytical unit may include training data. In some embodiments, the predictive data analysis apparatus 110 may be configured to generate a training engine that includes the training data for the analytical unit. For example, the predictive data analysis apparatus 110 may generate a training engine for an analytical unit based on the identified areas of improvement for the analytical unit. In some embodiments, the training engine may be specially customized for the analytical unit for which the training engine is generated or otherwise tailored to the analytical unit based on one or more features of the analytical unit. For example, generating the training engine for an analytical unit may include identify and/or extracting one or more features, such as learning features, associated with the analytical unit, and generating a training engine for the analytical unit based on the one or more features. In this regard, the training engine may be tailored to match the analytical unit in a manner that improves the effectiveness of the training engine. For example, where the analytical unit is a sales agent, the training engine may be configured to match the agent's learning features such as learning style. In some embodiments, the predictive data analysis apparatus 110 generates the training engine for an analytical unit or group of analytical units using a generative artificial intelligence model 140E. For example, a portion of the predictive performance data set for an analytical unit may comprise training data for the analytical unit and/or a training engine comprising the training data for the analytical unit.

As indicated above, the unit performance data and/or predictive performance data set generated for analytical units may be leveraged to facilitate and/or provide various insights, analysis, solutions, functionalities, capabilities, or the like, including for example, assessing current performance of analytical units, facilitating comparison among similar analytical units by providing performance ranks, assessing operating plans (e.g., schedules, or the like), providing recommended operating plans and/or operation plan modifications, identifying areas of opportunities to improve throughput and/or efficiency of analytical units, facilitating recognition and reward-based platforms and/or systems, monitoring and/or tracking performance metrics, providing for digital optimization, facilitating development of expertise, analyzing cross-output category opportunities, facilitating and/or performing hierarchical analysis with respect to a group of analytical units at different levels, assessing geographical interactivity (e.g., segmentation of analytical units into groups and mapping), identifying customer location and determining influence on performance of an analytical unit (e.g., in a product and sales domain, for example), generating behavior data with respect to customers of a client entity (e.g., in a product and sales domain, for example) utilizing customer experience ratings for analysis (e.g., in a product and sales domain, for example), etc.

### Example Apparatuses of the Disclosure

Having discussed example systems in accordance with the present disclosure, example apparatuses in accordance with the present disclosure will now be described.

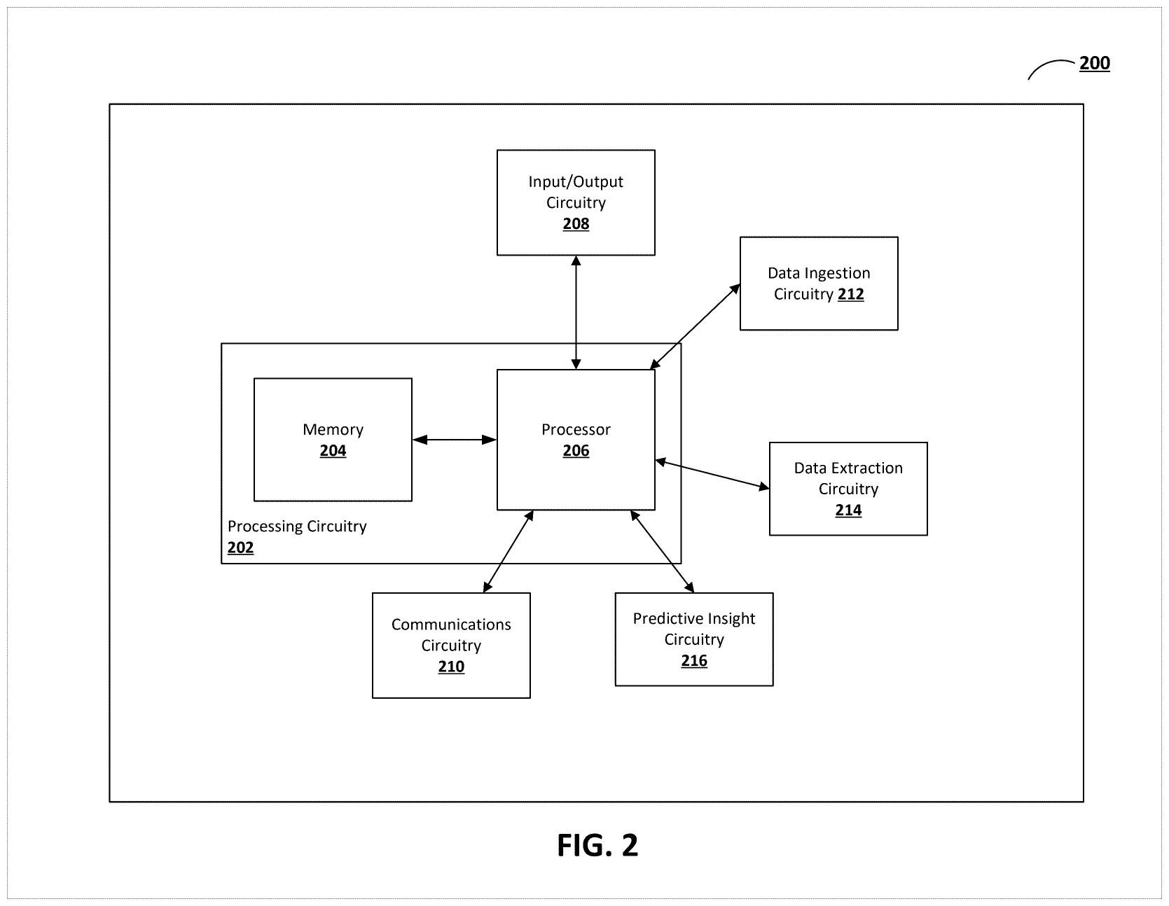

FIG. 2 illustrates a block diagram of an apparatus 200 in accordance with some example embodiments. For example, in some embodiments, the data ingestion apparatus 106, data extraction apparatus 108, and/or predictive data analysis apparatus 110 may be embodied by one or more apparatuses 200. In this regard, in some embodiments, the performance analysis computing system 101 or one or more portions (e.g., one or more individual apparatuses) thereof, if embodied in a particular embodiment, may be embodied by one or more apparatuses 200.

In some embodiments, the apparatus 200 may include a processing circuitry 202 as shown in FIG. 2. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the performance analysis computing system 101, the other devices interacting with the dynamic content extraction system, or any subset thereof may be performed by a single apparatus 200 or multiple apparatuses 200. In some embodiments, the apparatus 200 may comprise one or a plurality of physical devices, including distributed, cloud-based, and/or local devices.

Although some components are described with respect to functional limitations, it should be understood that the particular implementations necessarily include the use of particular computing hardware, such as the hardware shown in FIG. 2. It should also be understood that certain of the components described herein may include similar or common hardware. For example, two sets of circuitries for example, may both leverage use of the same processor(s), network interface(s), storage medium(s), and/or the like, to perform their associated functions, such that duplicate hardware is not required for each set of circuitry and a single physical circuitry may be used to perform the functions of multiple circuitries described herein. The use of the term “circuitry” as used herein with respect to components of the apparatuses described herein should therefore be understood to include particular hardware configured to perform the functions associated with the particular circuitry as described herein.

In some embodiments, “circuitry” may include processing circuitry, storage media, network interfaces, input/output devices, and/or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, and/or the like.

The apparatus 200 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, and/or other processing and management services according to one or more example embodiments. In some embodiments, the apparatus 200 or a portion(s) or component(s) thereof, such as the processing circuitry 202, may be embodied as or comprise a chip or chip set. In other words, apparatus 200 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (and/or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) and/or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry—in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, and/or one or more remote or “cloud” processor(s) external to the apparatus 200.

In some example embodiments, the memory 204 may include one or more non-transitory memory devices such as, for example, volatile and/or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions and/or the like for enabling the apparatus 200 to carry out various functions in accordance with one or more example embodiments. For example, the memory 204 may be configured to buffer input data for processing by the processor 206. Additionally or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, output circuitry 208 and/or communications circuitry 210, via a bus(es) for passing information among components of the apparatus 200.

The input/output circuitry 208 may provide output to the user or an intermediary device and, in some embodiments, may receive one or more indication(s) of user input. In some embodiments, the input/output circuitry 208 is in communication with processor 206 to provide such functionality. The input/output circuitry 208 may include one or more user interface(s) and/or include a display that may comprise the user interface(s) rendered as a web user interface, an application interface, and/or the like, to the display of a user device, a backend system, or the like. The input/output circuitry 208 may be in communication with the processing circuitry 202 to receive an indication of a user input at the user interface and/or to provide an audible, visual, mechanical, or other output to the user. As such, the input/output circuitry 208 may include, for example, a keyboard, a mouse, a joystick, a display, a touch screen display, a microphone, a speaker, and/or other input/output mechanisms. As such, the input/output circuitry 208 may, in some example embodiments, provide means for a user to access and interact with the apparatus 200. The processor 206 and/or input/output circuitry 208 comprising or otherwise interacting with the processor 206 may be configured to control one or more functions of one or more user interface elements through computer program instructions (e.g., software and/or firmware) stored on a memory accessible to the processor 206 (e.g., stored on memory 204, and/or the like).

The communications circuitry 210 may include one or more interface mechanisms for enabling communication with other devices and/or networks. In some cases, the communications circuitry 210 may be any means such as a device or circuitry embodied in either hardware, or a combination of hardware and software that is configured to receive and/or transmit data from/to a network and/or any other device or module in communication with the processing circuitry 202. The communications circuitry 210 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

In some embodiments, the apparatus 200 may include a data ingestion circuitry 212 which may include hardware components, software components, and/or a combination thereof configured to, with the processing circuitry 202, input/output circuitry 208 and/or communications circuitry 210, perform one or more functions associated with the data ingestion apparatus 106 (as described above with reference to FIG. 1). For example, the data ingestion circuitry 212 may access, facilitate access, receive process, manipulate, provide, or otherwise use, or make available for use, data (e.g., client performance data, and/or other data) used by one or more other components of the apparatus 200 through, for example, the use of applications or APIs executed using a processor, such as the processor 206. In some embodiments, the data ingestion circuitry 212 may interact with the memory 204, which may store the aforementioned data. It should also be appreciated that, in some embodiments, the data ingestion circuitry 212 may include a separate processor, specially configured field programmable gate array (FPGA), or application specific interface circuit (ASIC) to provide or otherwise facilitate access to such data used by one or more other components of the apparatus 200. The data ingestion circuitry 212 may also provide for communication with other components of the apparatus, system and/or external systems via a network interface provided by the communications circuitry 210.

In some embodiments, the apparatus 200 may include a data extraction circuitry 214 which may include hardware components, software components, and/or a combination thereof configured to, with the processing circuitry 202, input/output circuitry 208 and/or communications circuitry 210, perform one or more functions associated with the data extraction apparatus 108 (as described above with reference to FIG. 1). For example, the data extraction circuitry 214 may access, facilitate access, receive process, manipulate, provide, or otherwise use, or make available for use, data (e.g., unit performance data, and/or other data) utilized by the predictive data analysis apparatus 110 to generate predictive performance data sets through, for example, the use of applications or APIs executed using a processor, such as the processor 206. In some embodiments, the data extraction circuitry 214 may interact with the memory 204, which may store the aforementioned data. It should also be appreciated that, in some embodiments, the data extraction circuitry 214 may include a separate processor, specially configured field programmable gate array (FPGA), or application specific interface circuit (ASIC) to receive such data utilized by the data extraction circuitry 214. The data extraction circuitry 214 may also provide for communication with other components of the apparatus, system and/or external systems via a network interface provided by the communications circuitry 210.

In some embodiments, the apparatus 200 may include a predictive data analysis circuitry 216 which may include hardware components, software components, and/or a combination thereof configured to, with the processing circuitry 202, input/output circuitry 208 and/or communications circuitry 210, perform one or more functions associated with the predictive data analysis apparatus 110 (as described above with reference to FIG. 1). For example, the predictive data analysis circuitry 216 may access, facilitate access, receive process, manipulate, provide, or otherwise use, or make available for use, certain data (e.g., unit performance data, predictive performance data set, and/or the like) used by one or more other components of the apparatus 200 through, for example, the use of applications or APIs executed using a processor, such as the processor 206. In some embodiments, the predictive data analysis circuitry 216 may interact with the memory 204, which may store the aforementioned data. It should also be appreciated that, in some embodiments, the predictive data analysis circuitry 216 may include a separate processor, specially configured field programmable gate array (FPGA), or application specific interface circuit (ASIC) to manage access and use of such data. The predictive data analysis circuitry 216 may also provide for communication with other components of the apparatus, system and/or external systems via a network interface provided by the communications circuitry 210.

### Example Processes for Data Ingestion Process

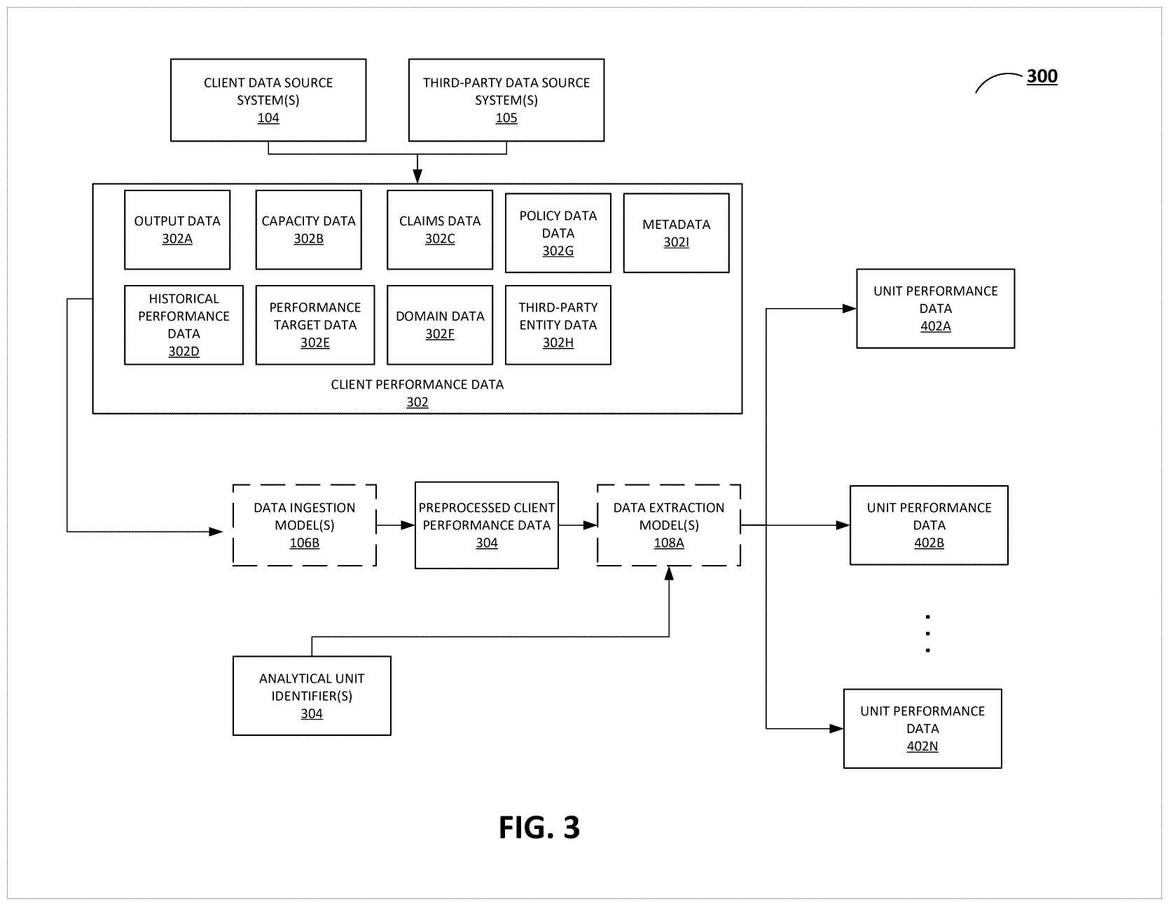

FIG. 3 is a data flow diagram 300 showing example data structures for data ingestion in accordance with at least some embodiments discussed herein. In some example embodiments, the data structures and processes shown and described with respect to the data flow diagram of FIG. 3 may be generated, performed, and/or otherwise facilitated by the various systems and apparatuses shown and described with respect to FIGS. 1-2.

As indicated, various embodiments of the present disclosure make important technical contributions to performance analysis techniques. In particular, systems and methods are disclosed herein that implement a multi-layer technique configured to ingest performance data at a client entity level or at sub-increment levels of the client entity and generate predictive performance data sets at the various levels. By doing so, the techniques of the present disclosure improve the technological field of performance data analysis.

In some embodiments, client performance data 302 for a client entity is obtained from one or more data sources. In some embodiments, client performance data 302 is data associated with a client entity, including data generated by the client entity and/or data generated about the client entity as described above. Additionally, in some embodiments, client performance data 302 may include data related to a domain associated with the client entity. As described above with respect to FIG. 1, the client performance data 302 may include, but not limited to, one or more of output data 302A for the client entity, which may include unit output data for each of one or more analytical units of the client entity; capacity data 302B for the client entity, which may include unit capacity data for each of one or more analytical units of the client entity; claims data 302C for the client entity, which may include unit claims data for each of one or more analytical units of the client entity; historical performance data 302D for the client entity, which may include unit historical performance data for each of one or more analytical units of the client entity; performance target data 302E for the client entity, which may include unit performance target data for each of one or more analytical units of the client entity; domain data 302F (e.g., market trend data, or the like); policy data 302G, third-party entity data 302H, metadata 302I, or the like.

As shown in FIG. 3, the client performance data 302 or a portion of the client performance data 302 may be received from one or more client data source systems 104 associated with the client entity. As further shown in FIG. 3, alternatively or additionally, the client performance data 302 or a portion of the client performance data 302 may be received from one or more third-party data source systems 105. The client performance data 302 may be obtained from the one or more client data source systems 104 and/or the third-party data source systems 105 via any of a plurality of techniques. In some embodiments, one or more data ingestion model(s) 106B may be leveraged to obtain the client performance data 302 and/or preprocess the client performance data 302 as described above with respect to FIG. 1. By way of example, where a client data source system 104 or a third-party data source system 105 includes a website, the client performance data 302 or a portion thereof may be obtained from the website via web scraping and/or or other data extraction techniques. By way of another example, where client performance data 302 is stored by a client data source system 104 or a third-party data source system 105 in a PDF document or similar document file formats, the client performance data 302 may be obtained from the PDF document by extracting the client performance data 302 from the PDF document using OCR technique and/or a data ingestion model 106B. The data ingestion model 106B, for example, may be configured to leverage an OCR algorithm or the like to extract the client performance data from the PDF documents. By way of yet another example, the client performance data 302 or a portion thereof may be received from a client data source system 104 and/or a third-party data source system 105 via one or more APIs, webhooks, wired or wireless communication network, or the like.

In some embodiments, one or more data preprocessing operations is performed on the client performance data using one or more data ingestion models 106B. For example, the client performance data 302 obtained from the client data source system(s) 104 and/or third-party data source system(s) may be applied to one or more data ingestion models 106B that have been trained, configured, and/or the like to perform one or more preprocessing operations on the client performance data 302 to output preprocessed client performance data 304. The one or more data preprocessing operations may include one or more of the data preprocessing operations discussed above with reference to FIG. 1.

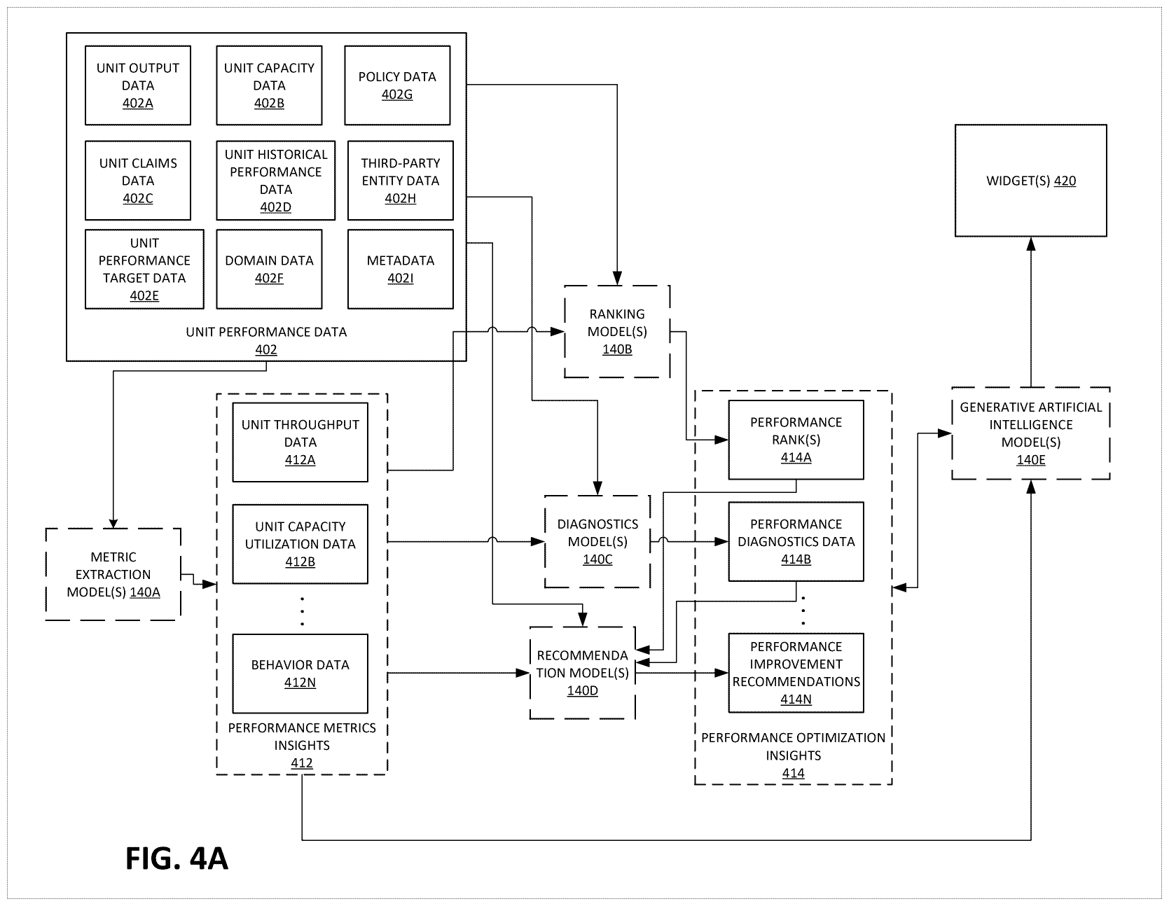

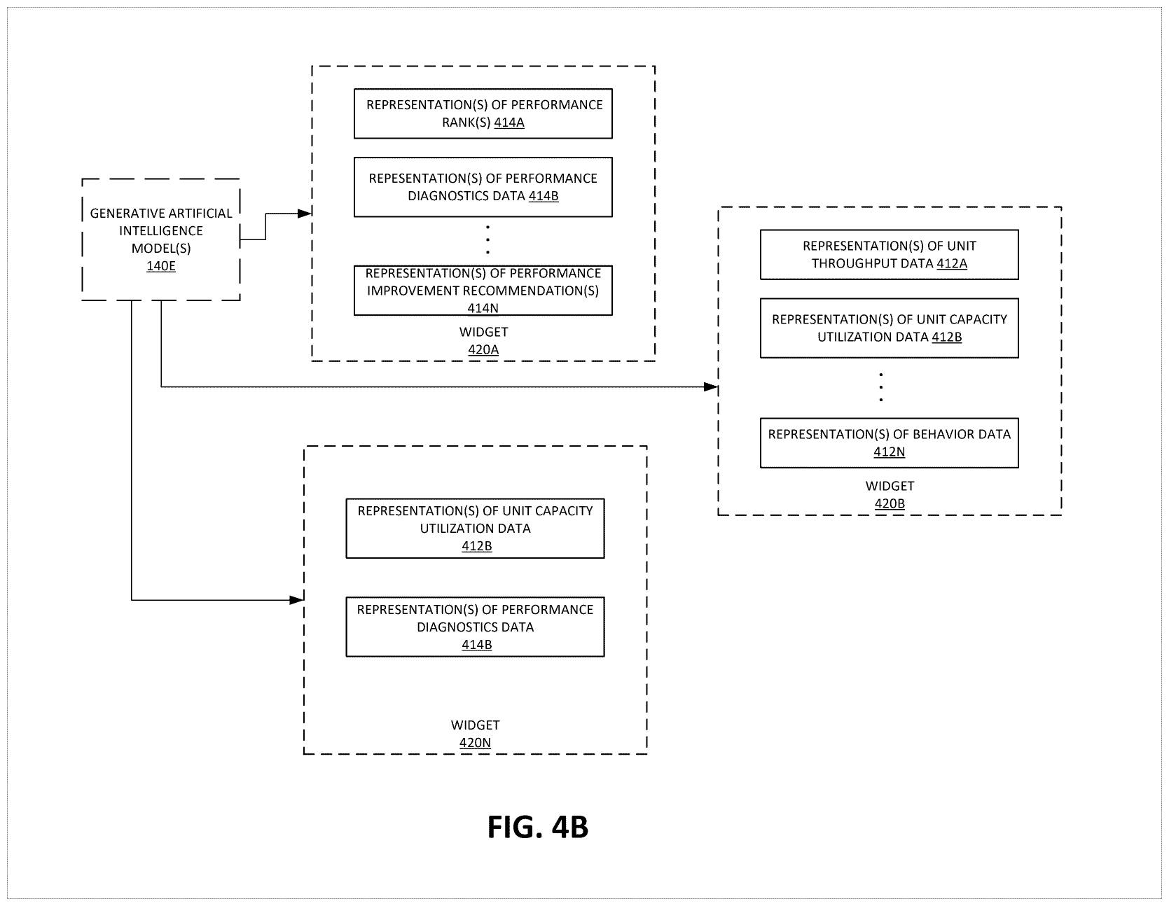

The preprocessed client performance data 304 may include a collection of one or more unit performance data. In this regard, in some embodiments, the preprocessed client performance data 304 is applied to one or more data extraction models 108A to extract the unit performance data 402 (e.g., 402A-N). The one or more data extraction models 108A may be trained, configured, or the like to extract the unit performance data 402 using one or more extraction techniques as discussed above with reference to FIG. 1. As shown in FIG. 4A, in some embodiments, the unit performance data 402 include one or more of unit output data 402A that describes the quantity of output by the analytical unit over a specified time period (e.g., number of springs output by a coiling machine over N hours of operation, number of printed sheets output by a printing machine over N hours of operation, number of computing tasks from a processing queue processed by a processor over a specified time period, number of sales made by a sales agent over a specified time period, or the like); unit capacity data 402B for an analytical unit that describes projected and/or target output for the analytical unit (e.g., opportunity data in a product and/or service provider domain example); unit claims data 402C that describes certain post-output events (e.g., return claims in a product and/or service provider domain example); unit historical performance data 402D; unit performance target data 402E; domain data 402F; policy data 402G; third-party data 402H; metadata 402I or the like.

### Example Processes for Predictive Performance Data Set Generation

FIGS. 4A-B show portions of a data flow diagram illustrating example data structures for predictive performance data set generation process in accordance with at least some embodiments discussed herein. In some example embodiments, the data structures and processes shown and described with respect to the data flow diagram of FIGS. 4A-B may be generated, performed, and/or otherwise facilitated by the various systems and apparatuses shown and described with respect to FIGS. 1-2

The data flow diagram shown in FIGS. 4A-B, illustrates a multi-stage process for generating predictive performance data sets comprising at least performance insights for analytical units, and providing the predictive performance data sets to a user via one or more renderable virtual widgets. By using the techniques of the present disclosure, holistic performance insights for analytical units associated with a client entity may be accessible to a user via a single platform with specially configured virtual widgets and features that enables dynamic and user-friendly interaction with the predictive performance data sets.

In some embodiments, unit performance data 402 for an analytical unit is received. As described above with respect to FIGS. 1-3, the unit performance data 402 may be received, or otherwise originate, from one or more data sources. As described above with respect to FIG. 1, the analytical unit may be configured, trained, and/or the like to, individually and/or collectively with one or more other analytical units, perform one or more tasks, operations, or the like to generate one or more outputs. Alternatively or additionally, the analytical unit may be configured, trained, and/or the like to monitor and/or track the results, effects, successes, of the one or more outputs and/or other analytical units. The analytical unit, for example, may be a server configured to provide one or more computing services, a computer program configured to provide one or more software functionalities, a sales agent trained to perform one or more activities related to offering of product and/or services, a storage system configured to store data, a software developer agent trained to perform one or more activities related to software application development and/or deployment, or the like. As described above, in some embodiments, the analytical unit may be associated with a client entity. For example, the analytical unit may represent a component and/or resource of the associated client entity. In a product and/or service provider domain, for example, the analytical unit may be a sales agent of a retail store, a store manager of a retail store, a retail store building, a manufacturing building, an operating machine, a point of sale (POS) device, or the like.

As described with respect to FIG. 1, the client entity may include one or more analytical units configured to perform individual and/or coordinated functions, tasks, or activities associated with the client entity to generate one or more outputs. The client entity may include a network, system, or other logical arrangement of the one or more analytical units. The client entity, for example, may be an operating machine/equipment (e.g., spring coiling machine, grinding machine, industrial oven, printing machine, or the like), a computing system (e.g., server system, communications network system, storage system, mobile device, software application, operating system, or the like), a product and/or service provider (e.g., business, organization, corporation, or the like), manufacturing facility, retail store, or the like. In some examples, a client entity may itself be an analytical unit of another client entity. In a computing system domain, for example, a server may be an analytical unit of a client entity that is a distributed server system and may also be a client entity associated with one or more analytical units such as a processor, a memory device, or the like. As another example, in a product and/or service provider domain, a retail store, for example, may be an analytical unit of a client entity that is mobile device provider and may also be a client entity associated with one or more analytical units such as sales agents, mobile device-related software applications, or the like. In this regard, one or more performance analysis techniques described herein is configured to provide performance data analysis for a client entity at different levels of granularity.

In some embodiments, the analytical unit is associated with an analytical unit identifier configured to uniquely identify the analytical unit from other analytical units. In some embodiments, a client entity is associated with a client entity identifier configured to uniquely identify the client entity from other client entities.

In some embodiments, the unit performance data 402 is applied to one or more trained performance analysis models 140 to generate a predictive performance data set comprising performance metrics insights 412 and/or performance optimization insights 414 for the analytical unit. For example, the predictive performance data set may be generated by analyzing the unit performance data 402 using the one or more trained performance analysis models 140 as described above with respect to FIG. 1.

Non-limiting examples of performance metrics insights and performance optimization insights that may be generated for the analytical unit are described above with respect to FIG. 1. By way of illustration, where the analytical unit is mobile device, the predictive performance data set may include one or more performance ranks for the mobile device for one or more performance categories (e.g., battery usage rank, processor speed rank, processor usage rank, or the like); performance data for the mobile device for one or more functionalities of the mobile device (e.g., network connectivity performance data, voice and/or data connectivity data); performance issues associated with the mobile device (e.g., high battery discharge rate, reduced processor speed, susceptibility to malware, defective charging port, or the like); root cause of identified performance issues; customized improvement recommendations for the mobile device or one or more components thereof (e.g., solution recommendation; re-configuration data for resolving performance issue, automatic performance issue resolution, or the like). By way of yet another illustration, where the analytical unit is a sales agent of a product and/or service provider, the predictive performance data set may include one or more of performance ranks for the sales agent for one or more performance categories (e.g., sales rank, attach rank, return rank, remorse rank, or the like); performance data for the sales agent (e.g., sales opportunities data, actual sales data, attach rate data (e.g., percent of actual sales data relative to sales opportunities data); performance issues associated with the analytical unit; root cause of identified performance issues; customized performance improvement recommendations specifically tailored for the analytical unit; return rate, or the like.

In some embodiments, applying the one or more trained performance analysis models 140 to generate the predictive performance data set is a multi-stage process, as noted above. For example, as shown in FIG. 4A, in such embodiments, the unit performance data 402 may be applied to a metric extraction model 140A from the one or more performance analysis models 140 to identify and/or generate performance metrics insights for the analytical unit. In some embodiments, the performance metrics insight 412 include, but not limited to, one or more of unit throughput data 412A, unit capacity utilization data 412B, or behavior data 412N.

The performance metrics insights 412 may be applied to one or more other performance analysis models 140 to generate performance optimization insights such as performance rank 414A, performance diagnostics data 414B, performance improvement recommendations 414N, or the like. For example, in some embodiments, the performance metrics insights 412 or a portion thereof may be provided as input to one or more ranking models 140B trained, configured, or the like to generate performance ranks for the analytical unit for one or more performance categories by analyzing the performance metrics insights with respect to unit performance target data 402E for the analytical unit. In some embodiments, the performance metrics insights 412 or a portion thereof may be provided as input to one or more diagnostics models 140C trained, configured, or the like to generate performance diagnostics data 414B for the analytical unit by analyzing the performance metrics insights 412 or a portion thereof using one or more machine learning algorithms. In some embodiments, the performance metrics insights 412 or a portion thereof may be provided as input to one or more recommendation models 140D trained, configured, or the like to generate performance improvement recommendations for the analytical unit by analyzing the performance metrics insights using one or more machine learning algorithms.

It will be appreciated that the aforementioned performance optimization insights (e.g., performance rank(s) 414A, performance diagnostics data 414B, and performance improvement recommendations 414N) are provided as examples and not intended to be limiting. In some other embodiments, the performance optimization insights may include additional performance optimization insights and/or may include different performance optimization insights.

Alternatively or additionally, in some embodiments, the performance optimization insights 414 may be generated using one or more generative artificial intelligence models 140E of the performance analysis models 140. In such embodiments, the performance metrics insights 412 or a portion thereof may be provided to as input to the one or more generative artificial intelligence models 140E in a prompt or via other input mechanisms. The generative artificial intelligence model(s) 140E may be trained, configured, or the like to process the performance optimization insights 414 and output the performance optimization insights. In some embodiments, the generative artificial intelligence model 140E may be a pre-trained large language model (LLM).

In some embodiments, and as shown in FIG. 4B, one or more representations of at least a portion of the predictive performance data set is generated. For example, one or more of textual representations (e.g., natural language text), graphical representations, pictorial representations (e.g., images), video representations, or the like may be generated for the predictive performance data set or a portion thereof. In some embodiments, one or more generative artificial intelligence models 140E of the performance analysis models 140 may be leveraged to generate the representations. In such embodiments, the predictive performance data set of a portion thereof may be provided to as input to the one or more generative artificial intelligence models 140E in a prompt or via other input mechanisms. The generative artificial intelligence model(s) 140E may be trained, configured, or the like to process the predictive performance data set and output the one or more representations.

The one or more representations may be embodied by or otherwise accessible via one or more virtual widgets 420A-N. As shown in FIG. 4B, each virtual widget 420A-N may include representations of one or more portions of the predictive performance data set. For example, portions of the predictive performance data set may be selected and included in a particular virtual widget. For example, in some embodiments, a first virtual widget may be associated with performance optimization insights 414 and may include representations of the performance ranks 414A for the analytical unit, representations of the performance diagnostics data 414B for the analytical unit, and/or representations of the performance improvement recommendations 414N for the analytical unit. As further shown in FIG. 4B, a second virtual widget 420B may be associated with performance metrics insights 412 and may include representations of the unit throughput data 412A for the analytical unit, unit representations of the unit capacity utilization data 412B for the analytical unit, and/or representations of the behavior data 412N associated with the analytical unit with respect to one or more third-party entities. As further shown in FIG. 4B, a third virtual widget may include representations of unit capacity utilization data 412B and representations of performance diagnostics data 414B. It would be appreciated that other virtual widgets may include different combinations of the portions of the predictive performance data set.

The virtual widgets 420A-N may be generated using any of a variety of techniques and/or models including one or more of the performance analysis models 140. For example, in some embodiments, the virtual widgets 420A-N may be generated using one or more generative artificial intelligence models, such as one or more of the generative artificial intelligence models 140E. For example, in some embodiments where the one or more representations are generated using a generative artificial intelligence model(s) 430E, the generative artificial intelligence model(s) 430E may be configured to generate one or more virtual widgets 420A-N comprising the one or more representations, and output the one or more virtual widgets 420A-N. For example, as described above with respect to FIG. 1, a prompt (or other input data) may be generated and provided to a generative artificial intelligence model 140E to generate one or more virtual widgets 420A-N comprising the one or more representations based on the prompt. The prompt, for example, may include data that describes the desired representation type for a respective portion of the predictive performance data set. In some embodiments, the generative artificial intelligence model(s) 140E may be trained, configured, or the like to automatically determine a suitable representation for a respective portion of the predictive performance data set. In some embodiments, the virtual widgets 420A-N may be generated using other models and/or other techniques.

In some embodiments, the one or more renderable virtual widgets 420A-N each comprising one or more representations of a respective portion of the predictive performance data set are displayed on a screen of a user device such as user device 102. The virtual widgets 420A-N may be selectable virtual widgets. In some embodiments, in response to a virtual widget selection indication, a user interface comprising the representations of the corresponding portion of the predictive performance data set associated with the virtual widget selected is displayed on a screen of the user device 102. For example, in response to a virtual widget selection indication indicative of a selection of a particular virtual widget rendered on the screen of the user device 102, a corresponding user interface comprising the representations of the portion of the predictive performance data set associated with the virtual widget may be rendered on the screen of the user device. As described above, in some embodiments, the user device 102 may be an AR device. For example, the user device may be an AR smart glasses, AR headset, AR smart phone, AR tablet, or the like. In such embodiments, Alternatively or additionally, in response to a virtual widget selection indication indicative of a selection of a particular virtual widget rendered on the AR screen of the AR device, representations of the portion of the predictive performance data set associated with the virtual widget may be displayed within the virtual widget. In some embodiments, the virtual widget displayed on a screen of an AR device may depend on location data. For example, in some embodiments, the virtual widget displayed on the screen of the user device may include representations of a predictive performance data set that is associated with a current location in the field of view of the AR device.

In some embodiments, the predictive performance data set displayed in the AR screen, via the virtual widgets, may be tailored to or otherwise customized for the user associated with the AR device (e.g., the user holding, wearing, or otherwise using the AR device) in accordance with the various embodiments of tailoring the analysis described herein. For example, the virtual widgets and/or predictive performance data sets in the virtual widgets displayed on the screen of the user may be based on the user identifier and/or one or more other data sets associated with the user, such that different users may receive different predictive performance data sets, via the virtual widgets displayed on the AR screen, for the same one or more analytical units (e.g., predictive performance data sets tailored for specific users). In this regard, each user associated with an AR device may receive custom virtual widgets (e.g., tailored to the user) based on the specific user data (e.g., metadata like user ID, role, and/or the like). For example, a network engineer associated with an AR device may receive performance insights that include network efficiency improvement recommendations while the site manager associated with an AR device may receive performance insights that include staffing recommendations. As another example, a first user associated with core temperature monitoring of a computer system and wearing or holding an AR device may receive predictive performance data set relevant to optimizing the core temperature of the analytical unit while a second user associated with storage space capacity and wearing or holding an AR device may receive predictive performance data set relevant to optimizing the storage space of the analytical unit, in some instances based on the same initial unit performance data.

### Example Methods

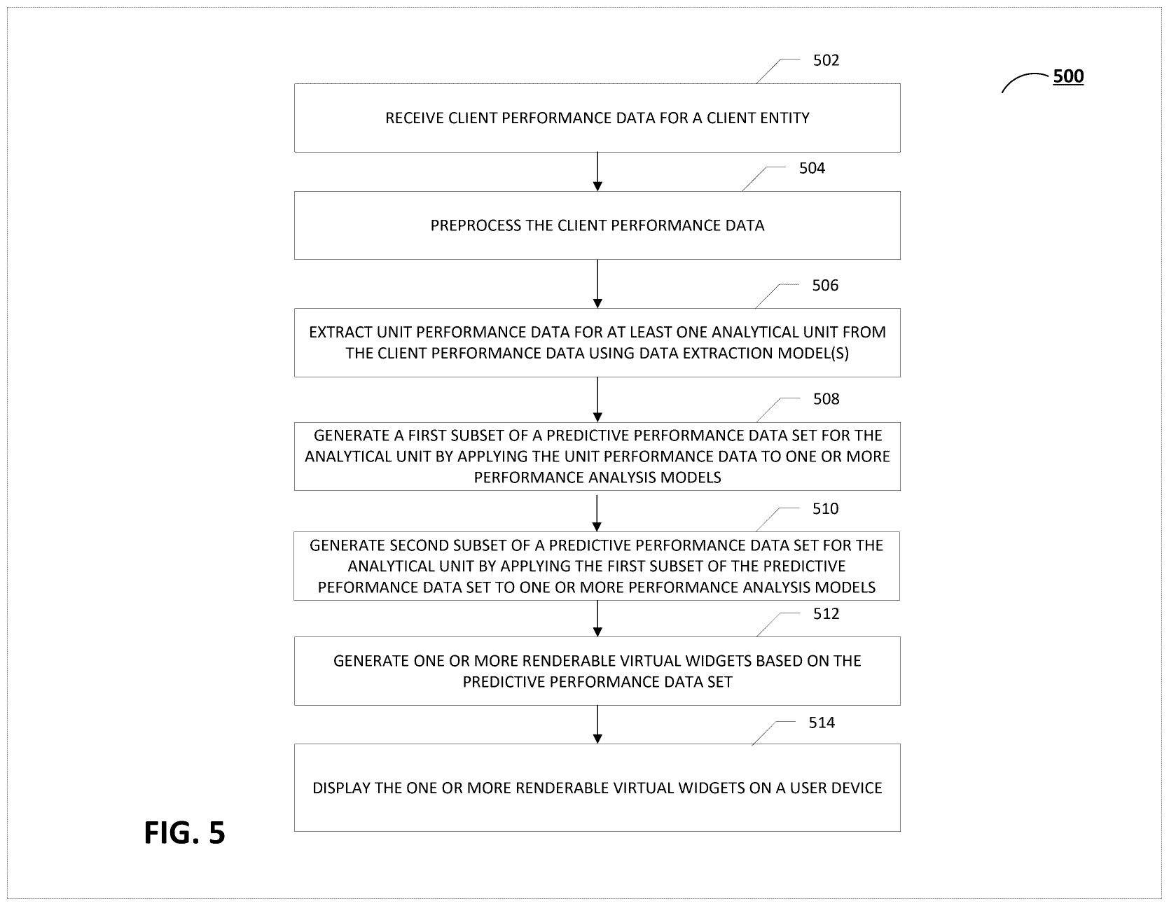

FIG. 5 illustrates an example flowchart depicting operations for predictive performance analysis in accordance with at least some example embodiments of the present disclosure. As depicted at block 502, the process 500 begins with receiving client performance data for a client data. In some embodiments, the client performance data is received from one or more data sources, which may include client data source systems and/or third-party data source systems.

At block 504, the process continues with preprocessing the client performance data. For example, one or more of data cleaning, data transformation, feature engineering, dimensionality reduction, or the like may be performed on the client performance data.

At block 506, the process continues with extracting unit performance data for at least one analytical unit from the client performance data using one or more data extraction models. In some embodiments, the unit performance data may be extracted based on the analytical unit identifier and/or utilizing one or more of a plurality of extraction techniques (as described above with respect to FIG. 1).

At block 508, the process continues with generating a first subset of a predictive performance data set for the analytical unit by applying the unit performance data to one or more performance analysis models. In some embodiments, the first subset of the predictive performance data set includes performance metrics insights for the analytical unit. In some embodiments, the performance metrics insights include one or more of unit throughput data for the analytical unit, unit capacity utilization data for the analytical unit, behavior data associated with the analytical unit with respect to one or more third-party entities, or the like.

At block 510, the process continues with generating a second subset of the predictive performance data set for the analytical unit by applying the first subset of the predictive performance data set to one or more performance analysis models. In some embodiments, the second subset of the predictive performance data set comprise performance optimization insights for the at least on analytical unit. In some embodiments, the performance optimization insights include performance ranks for the analytical unit, performance diagnostics data for the analytical unit, performance improvement recommendations for the analytical unit, or the like.

At block 512, the process continues with generating one or more renderable virtual widgets comprising one or more representations of at least a portion of the predictive performance data set for the analytical unit. In some embodiments, a first virtual widget is associated with or otherwise comprise the first subset of the predictive performance data set and a second virtual widget is associated with or otherwise comprise the second subset of the predictive performance data set. Additionally, in some embodiments, one or more widgets comprise a combination of portions of the first subset of the predictive performance data set and portions of the second subset of the predictive performance data set.

In some embodiments, the predictive performance data set for an analytical unit that is provided to the user (e.g., via virtual widgets on a screen of the user device associated with the user) may be tailored to the user. For example, the predictive data set and user data (e.g., user identifier, user role, user permissions data, or the like) associated with the user may be applied to a performance analysis model that is configured to extract portions of the predictive data set for the analytical unit that is relevant to the user based on the user data. In some embodiments, the predictive performance data sets may be generated based at least in part on user data associated with the user whom the predictive performance data set will be provided, where the predictive performance data set generated for the analytical unit with respect to a first user may be different from the predictive performance data set generated for the analytical unit with respect to a second user.

In some embodiments, the one or more representations of the at least a portion of the predictive performance data set for the analytical unit includes a textual representation of performance improvement recommendations for the analytical unit. In some embodiments, the textual representation of the performance improvement recommendations is generated using a generative artificial intelligence model of the one or more trained performance analysis models and based on the at least a portion of the predictive performance data set for the analytical unit.

In some embodiments, the performance improvement recommendations comprise training data for the analytical unit. In some embodiments, the training data is generated in response to determining that the unit performance data for the analytical unit fails to satisfy one or more performance targets. In some embodiments, the training data is unit-specific training data in that the training data for the analytical unit may be tailored or otherwise customized for the analytical unit based on, for example, one or more features of the analytical unit and/or one or more portions of the predictive data set for the analytical unit (e.g., performance diagnostics data, performance metrics insights, or the like). For example, training data for the analytical unit may be generated based on identified areas of improvement for the analytical unit.

In some embodiments, a training engine is generated for the analytical unit. The training engine, for example, may comprise the training data for the analytical unit. In some embodiments, the training engine may be specially customized for the analytical unit or otherwise tailored to the analytical unit based on one or more features of the analytical unit. For example, generating the training engine for an analytical unit may include identify and/or extracting one or more features, such as learning features, associated with the analytical unit, and generating a training engine for the analytical unit based on the one or more features. In this regard, the training engine may be tailored to match the analytical unit in a manner that improves the effectiveness of the training engine. In some embodiments, the training engine is generated using a generative artificial intelligence model.

In some embodiments, generating the predictive performance data set may include, generating aggregated data set comprising unit performance data set associated with one or more second analytical units and generating based on the unit performance data for the analytical unit and aggregated data set, a portion of the predictive performance data set by comparing matching portions of the unit performance data and the aggregated data set. For example, the portion of the predictive performance data set may be indicative of a performance of the analytical unit with respect to one or more performance categories and the one or more second analytical units (to, for example, provide benchmarking).

At block 514, the process continues with displaying the one or more renderable virtual widgets on a screen of the user device. The virtual widgets may be displayed on the screen of a mobile device via one or more user interfaces associated with a mobile application platform and/or a web application platform. In this regard, a user may access the virtual widgets via the mobile application platform and/or web application platform. In some embodiments, at least one of the user interfaces includes at least one communications interface element. In response to user interaction with the communications interface element (e.g., selecting the user interface), a communications widget may be caused to be rendered on the screen of the user device to facilitate transmitting and/or receiving of messages between the user device and a second user device. In some embodiments, the communications interface element and/or communications widget may be leveraged to recommend and/or assign training to analytical units based on the corresponding predictive performance data set and/or training engine for the analytical unit. Additionally, the communications interface element and/or communication widget may be leveraged to track training recommended and/or assigned to an analytical unit.

In some embodiments, where the user device is an AR device or otherwise in an AR mode, the virtual widgets may be displayed on the screen of the AR device. The virtual widgets displayed on the screen of the AR device may be based on the location in the field of view of the AR device. For example, in some embodiments, a first location in the field of view of the AR device within a spatial region associated with the analytical units is detected. In response to detecting the first location, one or more virtual widgets comprising a portion of the predictive performance datasets associated with the analytical units associated with the location is displayed on the screen of the AR device. As the AR device (e.g., field of view thereof) is moved around the spatial region to scan the area, a second location within the field of view of the AR device that is associated with the analytical unit may be detected. In response to detecting the second location, one or more virtual widgets comprising a second portion of the predictive performance datasets for the analytical unit may be displayed on the screen of the AR device.

In some embodiments, the second location detected may be associated with a different analytical unit. For example, a first location in the field of view of the AR device within a spatial region associated with one or more first analytical units may be detected. In response to detecting the first location, one or more virtual widgets comprising predictive performance datasets associated with the first one or more analytical units associated with the location may be displayed on the screen of the AR device. As the AR device is moved around the spatial region to scan the area, a second location within the field of view of the AR device that is associated with one or more second analytical units that are different from the first one or more analytical units may be detected. In response to detecting the second location, one or more virtual widgets comprising predictive performance datasets for the one or more second analytical units associated with the location may be displayed on the screen of the AR device.

### Example User Interfaces and Screen Displays

As described above, the system 101 may provide a platform (e.g., a mobile application platform, a web application platform, or the like), which a user may access to interact with predictive performance data sets for analytical units, including viewing the predictive performance data sets, initiating predictive performance analysis tasks as described herein, providing input for predictive performance analysis task(s) as described herein, downloading predictive performance data sets, or the like. Each of the depicted user interfaces and screen displays herein should be understood to be examples that are non-limiting, and the various virtual widgets and other elements of the user interfaces and screen displays may be used to represent any output or other data representation or information described herein.

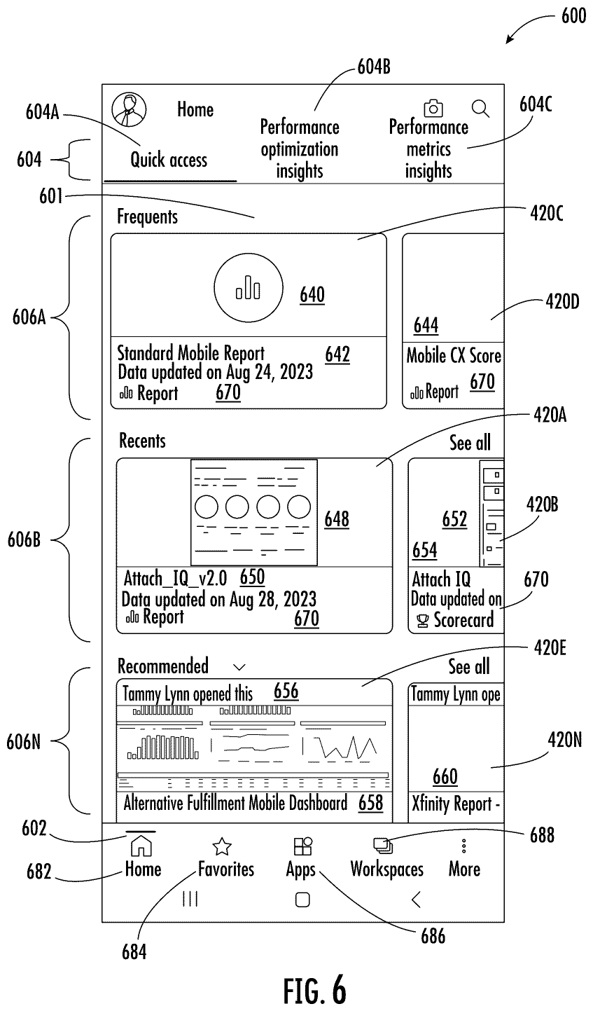

FIG. 6 illustrates an example performance user interface 600 that may be provided in accordance with some example embodiments. In this regard, FIG. 6 illustrates an example user interface that may be provided on a user device 102, such as a mobile device. The example user interface of FIG. 6 includes an access toolbar 604 configured to facilitate user friendly access and interaction with the predictive performance data sets (e.g., performance ranks, performance diagnostics data, performance improvement recommendations, unit throughput data, unit capacity utilization data, behavior data, and/or the like) provided via the performance user interface 600.

The access toolbar 604 may include one or more toggle elements configured to facilitate access to various portions of the predictive performance data set for an analytical unit or set of analytical units in an intuitive, user friendly, and organized manner. The one or more toggle elements in the access toolbar 604 includes a quick access toggle element 604A, a performance optimization insights toggle element 604B and a performance metrics insights toggle element 604C. Each toggle element may be configured to render a corresponding user interface when selected. The corresponding user interface may be rendered within the performance user interface 600. In would be appreciated that the access toolbar 604 may include other toggle elements such as an activity toggle element, a scorecard toggle element, or the like.

The quick access toggle element 604A may be configured to render a quick access user interface 601 that displays frequently accessed virtual widgets (e.g., virtual widgets that are frequently accessed (e.g., viewed, and/or the like) by a user associated with the user device and/or currently logged into the platform, recently accessed virtual widgets (e.g., the last N virtual widgets accessed by a user associated with the user device and/or currently logged into the platform, where N is an integer such 1, 3, 10, or the like), recommended virtual widgets (e.g., virtual widgets recommended by the system 101 for the user associated with the user device and/or currently logged into the platform. In this regard, the system 101 may be configured to monitor and/or track user interaction with the predictive performance data sets in real-time and dynamically update the quick access user interface 601 based on the user interaction. For example, the system 101 may be configured to customize or otherwise tailor the virtual widgets displayed in the quick access user interface 601 to the user associated with the user device and/or currently logged into the platform. In this manner, the system 101 obviates the need for a user to navigate through multiple interfaces to access relevant predictive performance data sets, portions thereof, or other relevant information. This in turn, facilitates efficient use of computing resources.

As shown in FIG. 6, the system 101 may be configured to group and/or arrange frequently accessed virtual widgets in proximity such as within a segment 606A of the quick access user interface 601. As further shown in FIG. 6, the system 101 may be configured to group and/or arrange recently accessed virtual widgets in proximity with each other such as within a segment 606B. As depicted in FIG. 6, the system 101 may be configured to group and/or arrange recommended virtual widgets in proximity with each other such as within a segment 606N. In this regard, the system 101 may be configured to further facilitate efficient and user-friendly access and interaction with predictive performance data sets.

The virtual widgets 420A-N may include one or more indicators configured to indicate (e.g., to a user) the information (e.g., predictive performance data set, portion of predictive performance data set, or other information) included in the respective virtual widget or otherwise accessible via the respective widget. As shown in FIG. 6, A first virtual widget 420A may include an image indicator 648 and/or text indicator 650 that, individually or collectively, indicate performance optimization insights for an analytical unit or group of analytical units. A second virtual widget 420B may include an image indicator 652 and/or text indicator 654 that, individually or collectively, indicate performance metrics insights for an analytical unit or a group of analytical units. A third virtual widget 420C may include a symbol indicator 640 and/or text indicator 642 that, individually or collectively, indicate a standard mobile report. A fourth virtual widget 420D may include a text indicator 644 that indicates a mobile scorecard. A fifth virtual widget 420E may include an image indicator 656 and/or text indicator 658 that, individually or collectively, indicate an alternative fulfillment mobile dashboard. A sixth virtual widget may include a text indicator 660 that indicates another report type (e.g., xfinity report, or the like).

The virtual widgets 420A-N may include metadata 670 such as, but not limited to, a description of the form of the information included in the respective virtual widget (e.g., report, scorecard, or the like); a timestamp (e.g., date or the like) corresponding to when the virtual widget or the information (e.g., predictive performance data set and/or other information) in the virtual widget was last accessed; a timestamp (e.g., date or the like) corresponding to when the virtual widget or the information (e.g., predictive performance data set and/or related data) in the virtual widget was last updated; the user identification (e.g., name, role, or the like) associated with the user that last accessed the virtual widget and/or the information in the virtual widget; the user identification associated with the user that last updated the virtual widget and/or the information in the virtual widget, and/or the like.

The virtual widgets 420A-N may be selectable virtual widgets configured for initiating display of information (e.g., predictive performance data set, portion of predictive performance data set, or other information) associated with the respective virtual widget in a respective corresponding user interface. The system 101, in response to receiving a virtual widget selection indication may be configured to identify the virtual widget selected by a user based on the virtual widget selection indication and render a user interface corresponding to the selected virtual widget and comprising the information (e.g., predictive performance data sets, and/or other information) associated with and accessible via the respective virtual widget. For example, the virtual widget 420A may be associated with performance optimization insights and in response to a virtual widget selection indication corresponding to the virtual widget 420A, the system 101 may cause rendering of a performance optimization insights interface 700 based on the virtual widget selection indication. As another example, the virtual widget 420B may be associated with performance metrics insights and in respond to a virtual widget selection indication corresponding to the virtual widget 420B, the system 101 may cause rendering of a performance metrics insights interface 800 based on the virtual widget selection indication corresponding the performance metrics widget 420B. Alternatively or Additionally, the performance optimization insights toggle element 604B may be configured for initiating display of the performance optimization insights interface 700 on a screen of the user device. Alternatively or Additionally, the performance metrics insights toggle element 604C may be configured for initiating display of the performance metrics insights interface 800 on a screen of the user device.

As shown in FIG. 6, the performance user interface 600 may include other interface elements configured to facilitate display of predictive performance data sets and/or other information in an efficient and user-friendly manner. Examples of such other interface elements include a home interface element 682, a favorites interface element 684, an apps interface element 686, a workspace interface element 688, or the like. The performance user interface 600, quick access user interface 601, performance optimization insights interface 700, and/or performance metrics insights interface 800 may be vertical and/or horizontal scrollable interfaces in that the respective interfaces may be scrolled vertically and/or horizontally (e.g., by a user). The respective interfaces (e.g., the performance user interface 600, quick access user interface 601, performance optimization insights interface 700, and/or performance metrics insights interface 800) may include a horizontal scroll bar and/or vertical scroll bar configured to facilitate scrolling of the respective interface horizontally or vertically respectively. For example, as shown in FIG. 6, the quick access user interface 601 includes a horizontal scroll bar 602 configured to facilitate horizontal scrolling of the quick access user interface 601. The quick access user interface 601 may also include a vertical scroll bar configured to facilitate vertical scrolling of the quick access user interface 601.

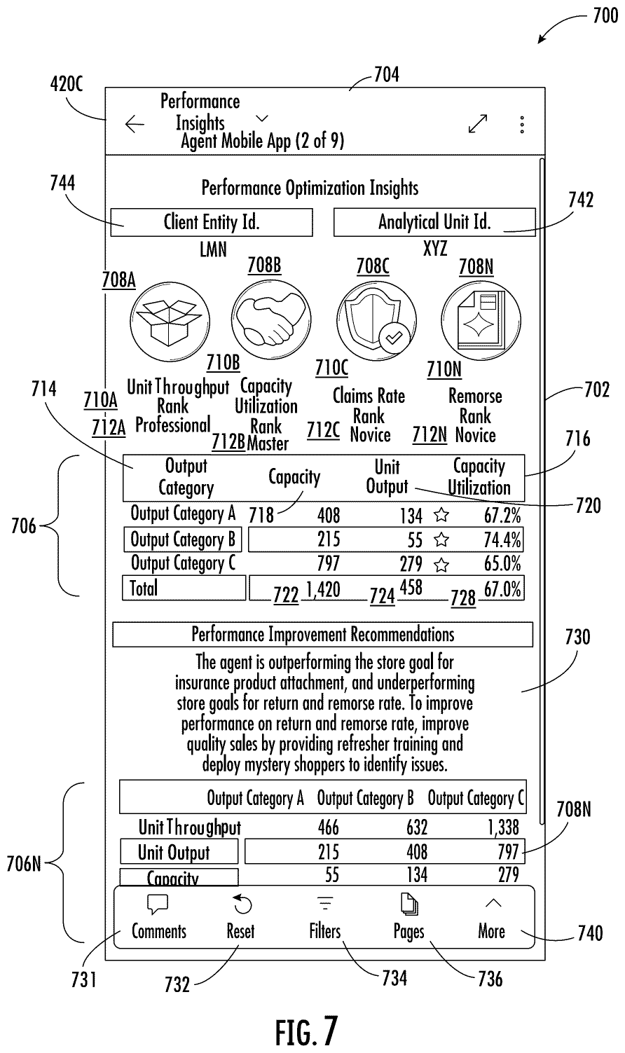

FIG. 7 illustrates an example performance optimization insights interface 700 that may be provided in accordance with some example embodiments. In this regard, FIG. 7 illustrates an example user interface that may be provided on a user device 102, such as a mobile device. The performance optimization insights interface 700 includes the analytical unit identifier 742 for the analytical unit whose predictive performance data set is being displayed or otherwise accessed via the performance optimization insights interface 700. The performance optimization insights interface 700 may also include other information associated with the analytical unit such as the client entity identifier 744, location data, or the like.

The performance optimization insights interface 700 includes representations of portions of the predictive performance data set for the analytical unit that are deemed or otherwise characterized as performance optimization insights as described above with reference to FIGS. 1-5. The performance optimization insights interface 700 includes representations of performance ranks for the analytical unit. In the illustrated example, the performance optimization insights interface 700 includes pictorial representations of the performance ranks 708A-N (e.g., color coded shapes, tokens, symbols, a combination thereof, or the like) and corresponding natural language textual representations of the performance ranks 710A-D (e.g., professional (pro), master, novice, and/or the like). As shown in FIG. 7, the performance optimization insights interface 700 includes the performance rank for each of a plurality of performance categories, including unit throughput 710A, unit capacity utilization 710B, claims rate 710C, and remorse 710N. As noted above, it would be appreciated that in some embodiments the performance rank categories may include other performance rank categories and/or may not include one or more of the performance rank categories illustrated in FIG. 7.

As further shown in FIG. 7, the performance optimization insights interface 700 includes a chart representation of capacity utilization 706 for the analytical unit including capacity utilization data 716 for the analytical unit for each of one or more output categories 714 along with the capacity data 718 and unit throughput data 720 for the analytical unit. As shown in FIG. 7, the chart representation of capacity utilization for the analytical unit may include natural language text and numerical values. As shown in FIG. 7, the chart representation of capacity utilization 706 further includes aggregate capacity 722, aggregate unit output 724, and aggregate capacity utilization 728.

As further shown in FIG. 7, the performance optimization insights interface 700 includes natural language textual representation of performance improvement recommendations 730 for the analytical unit. In the illustrated example of FIG. 7, the performance optimization insights interface 700, further includes a chart representation of capacity data and unit capacity for the analytical unit with respect to each of one or more output categories for the analytical unit.

As shown in FIG. 7, the performance optimization insights interface 700 may include other interface elements configured to facilitate display of predictive performance data sets for a user in an efficient and user-friendly manner. Examples of such other interface elements include a comments interface element 731, a reset interface element 732, a filter interface element 734, a pages interface element 736, a more interface element 740, or the like. The performance optimization insights interface 700 may be a vertical and/or horizontal scrollable interface. The performance optimization insights interface 700 may include a horizontal scroll bar configured to facilitate horizontal scrolling of the performance optimization insights interface 700. Alternatively or additionally, the performance optimization insights interface 700 may include a vertical scroll bar 702 configured to facilitate vertical scrolling of the performance optimization insights interface 700.

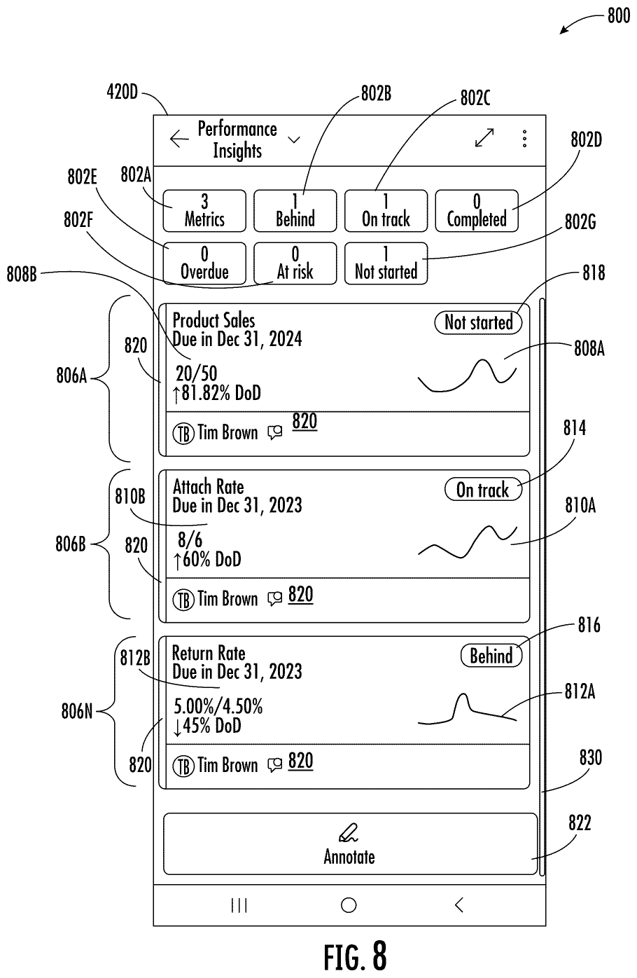

FIG. 8 illustrates an example performance metrics insights interface 800 that may be provided in accordance with some example embodiments. In this regard, FIG. 8 illustrates an example user interface that may be provided on a user device 102, such as a mobile device. The performance metrics insights interface 800 includes the analytical unit identifier for the analytical unit whose predictive performance data set is being displayed or otherwise accessed via the performance metrics insights interface 800. The performance metrics insights interface 800 may also include other data associated with the analytical unit such as the client entity identifier, location data, or the like.

The performance metrics insights interface 800 includes performance metrics tracking interface elements 802A-N configured to indicate the performance of the analytical unit with respect to one or more performance metrics. For example, the performance metrics tracking interface elements 802A-N include a first performance metrics tracking interface element 802A that displays the number of performance metrics (e.g., key performance indicators (KPI)) for the analytical unit that is being monitored, a second performance metrics tracking interface element 802B that displays the number of performance metrics for which the analytical unit is behind, a third performance metric tracking interface element 802C that display the number of performance metrics for which the analytical unit is on track, a fourth performance metric tracking interface element 802D that displays the number of completed tasks for the analytical unit, a fifth performance metric tracking interface element 802E that displays the number of overdue tasks for the analytical unit, a sixth performance metric tracking interface element 802F, and a seventh performance metric tracking interface element 802G that displays the number of tasks for which the analytical unit has not started.

In the illustrated example of FIG. 8, the performance metrics insights interface 800 includes one or more graphical tiles 806A-N that are each associated with a performance category for the analytical unit. Each graphical tile includes one or more representations of performance metrics insights for the analytical unit. In the illustrated example of FIG. 8, the performance metrics insights interface 800 includes a unit output graphical tile 806A that includes a trend graph representation 808A of the unit output for the analytical unit with respect to a specified period of time (e.g., time series graph of the unit output for the analytical unit) and a numerical representation 808B of the unit throughput data for the analytical unit relative to a performance target.

In the illustrated example of FIG. 8, the performance metrics insights interface 800 includes a capacity utilization graphical tile 806B that includes a trend graph representation 810A of the capacity utilization for the analytical unit and a numerical representation 810B of the capacity utilization for the analytical unit relative to the corresponding performance target.

In the illustrated example of FIG. 8, the performance metrics insights interface 800 further includes a claims graphical tile 806N that includes a trend graph representation 812A of the claims data for the analytical unit and a numerical representation 812B of the claims data for the analytical unit relative to the corresponding performance target.

As shown in FIG. 8, the trend graph representation 808A of the unit output, the trend graph representation 810A of the capacity utilization, and the trend graph representation 812A of the claims data are color-coded to indicate the status of the respective performance metric. For example, a green color-coded trend graph may indicate on-track status 814, a red color-coded trend graph may indicate a behind target status 816, and a white color-coded trend graph 818 may indicate a not started status (e.g., indication that the performance metric is not yet being monitored or tracked. The graphical, numerical, other textual, or other visualization styles of the various widgets may be used in connection with any other output or data representation.

As shown in FIG. 8, the graphical tiles 806A-N may be color coded to, for example, facilitate identification of the graphical tile 806A-N. For example, each of the graphical tiles 806A-N may have a different color strip 820 on a side of the respective graphical tile.

As shown in FIG. 8, the graphical tiles 806A-N each include a communications interface element 822. The system 101 may be configured cause rendering of a communications widget on the screen of the user device when the communications interface element 822 is selected. In some embodiments, the communications widget may be rendered in the performance metrics insights interface 800. In some embodiments, the communications widget may be rendered in another user interface. In this regard, the system 101 may be configured to provide a communications channel to facilitate communications between at least users of the mobile application platform and/or web application platform provided by the system 101. In some embodiments, the communications interface element and/or communications widget may be leveraged to recommend and/or assign training to analytical units based on the corresponding predictive performance data set and/or training engine for the analytical unit. Additionally, the communications interface element and/or communication widget may be leveraged to track training recommended and/or assigned to an analytical unit. As further shown in FIG. 8, the performance metrics insights interface 800 may include an annotate interface element configured to enable a user to make annotations via the performance metrics insights interface 800.

The performance metrics insights interface 800 may be a vertical and/or horizontal scrollable interface. The performance metrics insights interface 800 may include a horizontal scroll bar configured to facilitate horizontal scrolling of the performance metrics insights interface 800. Alternatively or additionally, the performance metrics insights interface 800 may include a vertical scroll bar 830 configured to facilitate vertical scrolling of the performance metrics insights interface 800.

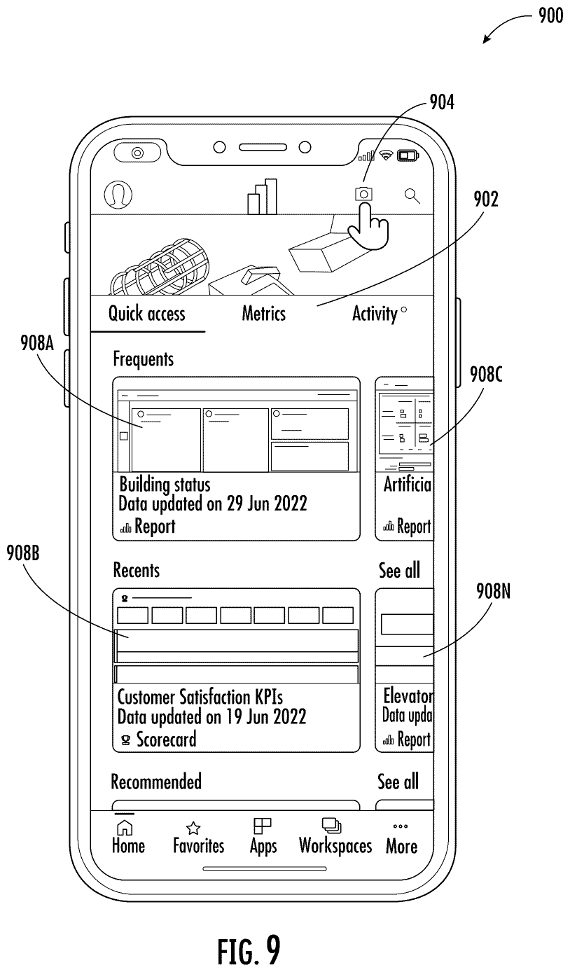

FIG. 9 illustrates an example performance user interface 900 that may be provided in accordance with some example embodiments. In this regard, FIG. 9 illustrates an example user interface that may be provided on a user device 102, such as an AR device (e.g., AR smart phone, AR headset, AR glasses, or the like). A screen of an example AR smart phone (also referred to herein as AR screen of the user device) is depicted in the example of FIG. 9. As shown in FIG. 9, the example user interface may include similar interface elements and features as the example performance user interface 600 depicted in FIG. 6. In the illustrated example of FIG. 9, the performance user interface 900 includes a camera interface element 904 configured to cause rendering of an AR mode selection element on the screen of the AR smart phone when selected.

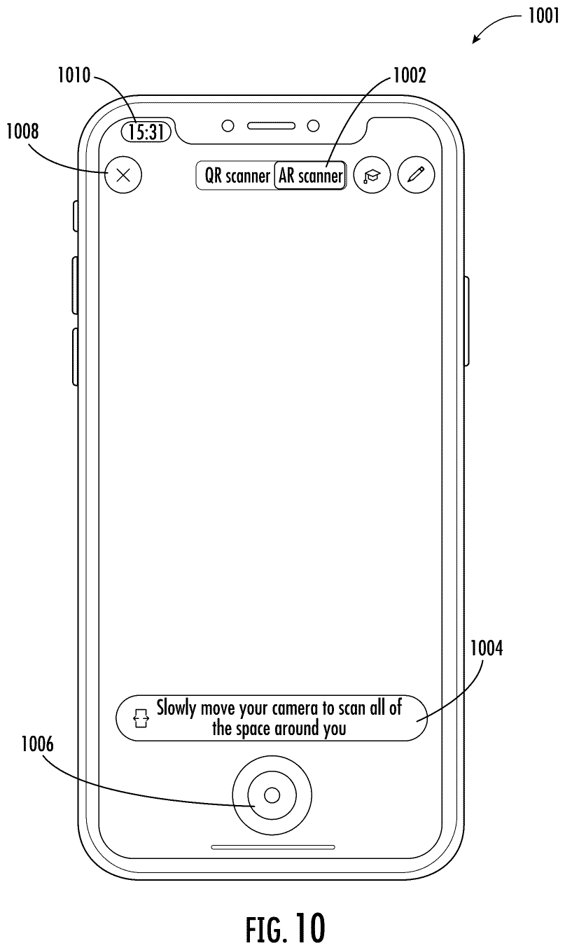

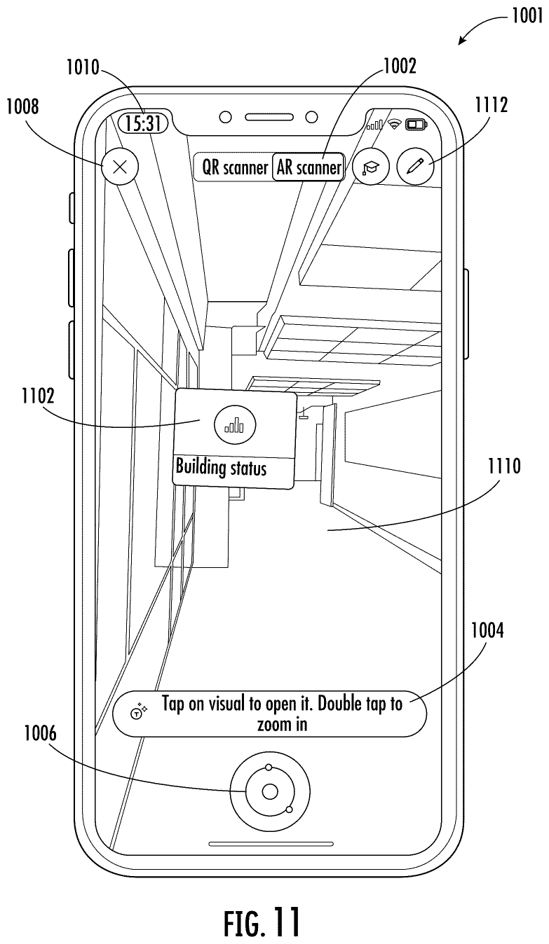

FIGS. 10-14 illustrate an AR screen 1001 in accordance with some example embodiments. As shown in FIG. 10, an instruction interface element 1004 may be rendered on the AR screen 1001 in response to selection of the AR mode selection element 1002 (e.g., AR scanner). The AR mode selection element 1002 may be used to enable “QR” code scanning functionality and/or AR scanning functionality (e.g., visual searching of an environment for matching with the various outputs described herein). In addition, an AR navigation map 1006 may be rendered on the AR screen 1001. The AR navigation map 1006 may be configured to indicate a current field of view of the AR device within a spatial region. Other elements such a close interface element 1008, date display, time display 1010, editing tools 1112, and/or the like may be rendered on the AR screen 1001. The instruction interface element 1004 may include instructions directing the user to slowly move the AR device (e.g., the camera associated with the AR device) to scan the spatial region 1110 in which the user is located. As shown in FIG. 11, a virtual widget 1102 corresponding to a location within the spatial region 1110 scanned by the AR device may be rendered on the AR screen 1001 in response to detecting the location by the system 101. As described herein, the virtual widgets may be positioned adjacent a spatial region that is relevant to the information presented and/or the user to whom it is presented (e.g., the wearer or holder of the AR device). For example, a manager, supervisor, or other higher level user may see relevant data for one or more analytical units in a spatial region associated with those respective analytical units. One or more lower level users or analytical units may see data associated with one or more tasks or functions visualized by virtual widgets in a location of the AR environment most relevant to the data displayed (e.g., data relevant to a server may be shown next to the server's location in the AR environment).

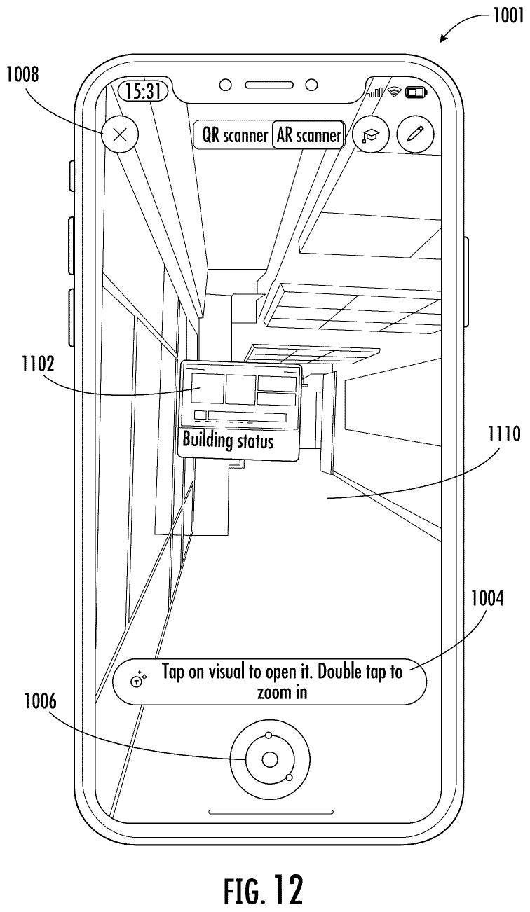

The instruction interface element 1004 may be updated to include instructions directing the user to select the virtual widget (e.g., to tap on the virtual widget 1102) in order to open the virtual widget 1102 and view the information (e.g., predictive performance data set and/or other information) contained in the virtual widget 1102 as shown in FIG. 12. As further shown in FIG. 12, representations of at least a portion of the predictive performance data set and/or other information for one or more analytical units associated with the location is displayed in the virtual widget 1102 in response to a virtual widget selection indication corresponding to the virtual widget. The instruction interface element 1004 may include instructions on how to zoom in the virtual widget. The instructions, for example, may be to double tap on the virtual widget to zoom in, or the like. The virtual widget 1102 may include any widget described herein, including any representation of any predictive performance data sets.

In some embodiments, as the AR device is moved around within the spatial region 1110, the system 101 may cause the virtual widget displayed on the AR screen to no longer be displayed on the AR screen in response to detecting that the current location in the field of view of the AR device is not associated with the one or more analytical units whose predictive performance data set was being rendered via the virtual widgets.

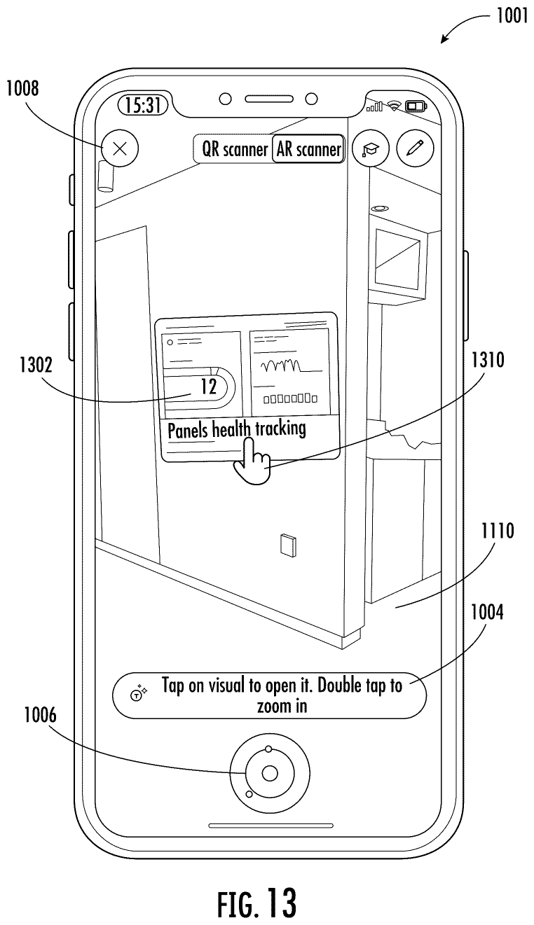

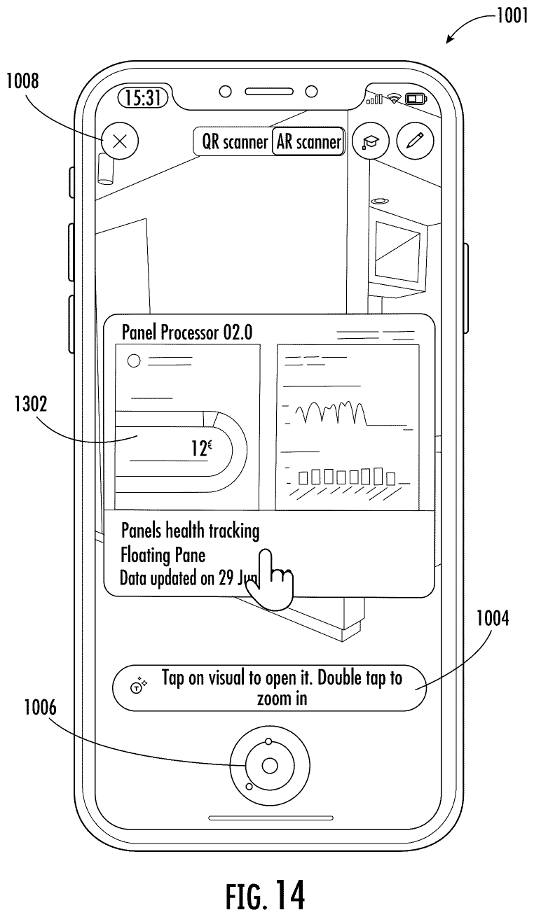

As the user traverses the environment, the AR device may track the AR device's location and camera orientation to visualize relevant data associated with the particular spatial region of the environment. In this manner, the location of the AR device may be tracked (e.g., via GPS or other position detection methods, including signal triangulation (e.g., via WiFi, Bluetooth, NFC, or other signals), dead reckoning, visual analysis of the images captured by the camera and comparison with a model of the environment, and/or other methods. For example, as the AR device is moved around within the spatial region 1110, the system 101 may detect a second location within the current field of view of the AR device that is associated with one or more other analytical units. In response to detecting the second location, the system 101 may cause rendering of another virtual widget 1302 on the AR screen 1001. As shown in FIG. 13, representations of at least a portion of the predictive performance data set and/or other information for the one or more other analytical units associated with the second location is displayed in the virtual widget 1302. As shown in FIG. 14, the virtual widget 1302 may be zoomed in by double tapping on the virtual widget 1302 (e.g., using selection interface element 1310).

The predictive performance data set displayed in the AR screen, via the virtual widgets, may be tailored to or otherwise customized for the user associated with the AR device (e.g., the user holding, wearing, or otherwise using the AR device). For example, the virtual widgets and/or predictive performance data sets in the virtual widgets displayed on the screen of the user may be based on the user identifier and/or one or more other data sets associated with the user, such that different users may receive different predictive performance data sets, via the virtual widgets displayed on the AR screen, for the same one or more analytical units (e.g., predictive performance data sets tailored for specific users). In this regard, each user associated with an AR device may receive custom virtual widgets (e.g., tailored to the user) based on the specific user data (e.g., metadata like user ID, role, and/or the like). For example, a network engineer associated with an AR device may receive performance insights that include network efficiency improvement recommendations while the site manager associated with an AR device may receive performance insights that include staffing recommendations. As another example, a first user associated with core temperature monitoring of a computer system and wearing or holding an AR device may receive predictive performance data set relevant to optimizing the core temperature of the analytical unit while a second user associated with storage space capacity and wearing or holding an AR device may receive predictive performance data set relevant to optimizing the storage space of the analytical unit, in some instances based on the same initial unit performance data.

The system 101 may be configured cause transfer from the AR mode (e.g., AR environment) to the performance user interface 600, 900, 1500 or other user interface associated with the mobile application platform or web application platform in response to receiving an indication of a selection of the close interface element 1008. Similarly, the system may seamlessly transition back to the AR mode after a user closes or otherwise indicates that they no longer need the displayed data via a selection on the interface or other direct or indirect input.

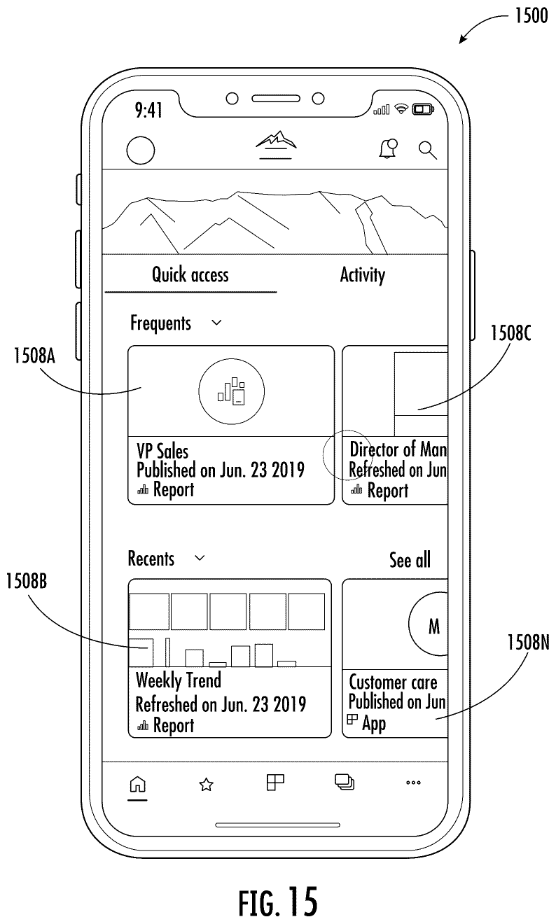

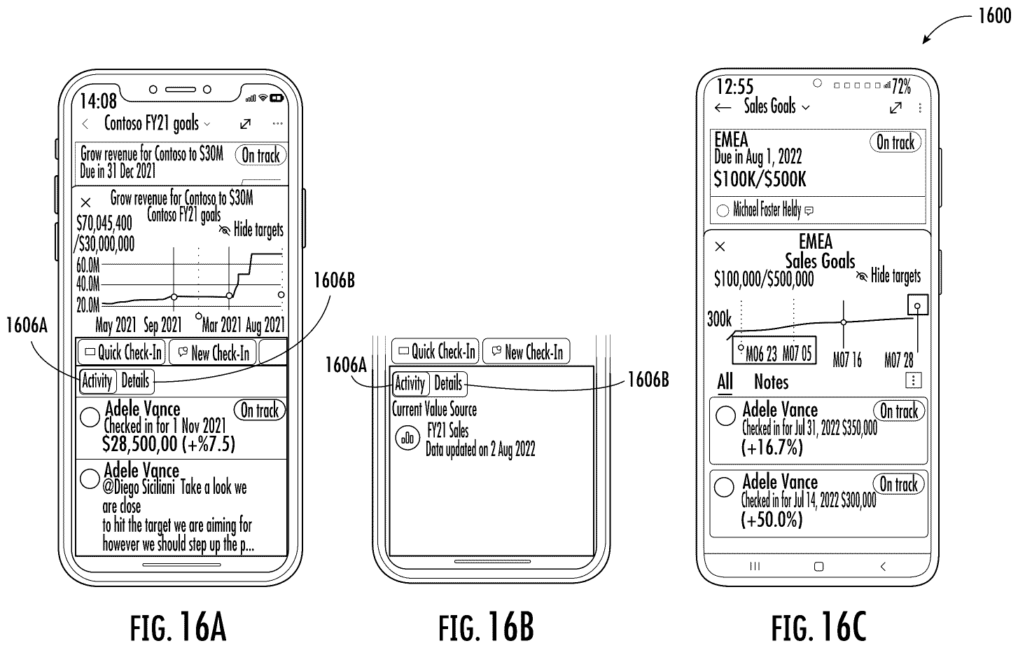

FIG. 15 illustrates another example performance user interface 1500 in accordance with some example embodiments. FIGS. 16A-C illustrate another example performance user interface 1600 in accordance with some example embodiments. As shown in FIG. 15, the performance user interface 1500 and performance user interface 1600 may include some similar interface elements and/or features as the example of FIG. 6. For example, FIG. 15 includes virtual widgets 1508A-N rendered in a quick access user interface. The performance user interfaces may be configured for rendering information associated with analytical units of a client entity. As shown in FIGS. 16A-C, the performance user interface 1600 may include one or more toggle interface elements 1606A and 1606B configured to facilitate navigation between two or more interfaces. For example, in the illustrated example of FIGS. 16A-C, the performance user interface 1600 includes an activity toggle interface element 1606A and a details toggle interface element 1606B.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
receiving, by one or more processors and from one or more data sources, unit performance data for an analytical unit;
applying, by the one or more processors, the unit performance data to one or more trained performance analysis models to generate a predictive performance data set for the analytical unit by analyzing the unit performance data using the one or more trained performance analysis models;
generating, by the one or more processors, one or more renderable virtual widgets comprising one or more representations of at least a portion of the predictive performance data set for the analytical unit; and
displaying, by the one or more processors, the one or more renderable virtual widgets on a screen of a user device.

2. The computer-implemented method of claim 1, wherein the user device comprises an augmented reality device, wherein the computer-implemented method further comprises:
detecting, a first location in a field of view of the augmented reality device within a spatial region associated with the analytical unit, wherein displaying the one or more renderable virtual widgets on the screen of the user device comprises displaying the one or more renderable virtual widgets on the screen of the augmented reality device in response to detecting the first location of the augmented reality device, wherein the at least a portion of the predictive performance data set for the analytical unit comprises a portion of the predictive performance data set that is associated with the first location;
detecting a second location in the field of view of the user device within the spatial region; and
in response to detecting the second location, displaying, on the screen of the augmented reality device, one or more representations of a second portion of the predictive performance data set that is associated with the second location.

3. The computer-implemented method of claim 1, wherein displaying the one or more renderable virtual widgets on the screen of the user device comprises displaying the one or more renderable virtual widgets in an interface on the screen of the user device.

4. The computer-implemented method of claim 3, wherein the interface includes at least one communications interface element, wherein the computer-implemented method is further configured to:
in response to user interaction with the communications interface element, cause rendering of a communications widget on the screen of the user device to facilitate transmitting and/or receiving of messages between the user device and a second user device.

5. The computer-implemented method of claim 1, wherein receiving the unit performance data comprises:
receiving client performance data comprising a plurality of individual unit performance data associated with a plurality of analytical units; and
applying the unit performance data to one or more data extraction models to identify the unit performance data from the plurality of individual unit performance data.

6. The computer-implemented method of claim 1, wherein generating the predictive performance data set for the analytical unit comprises:
applying the unit performance data to a first trained performance analysis model to generate a first subset of the predictive performance data set, wherein the first subset of the predictive performance data set includes performance metrics insights; and
applying the performance metrics insights to a second performance analysis model to generate a second subset of the predictive performance data set, wherein the second subset includes performance optimization insights.

7. The computer-implemented method of claim 1, wherein the one or more representations of the at least a portion of the predictive performance data set for the analytical unit includes a textual representation of performance improvement recommendations for the analytical unit, wherein the textual representation of the performance improvement recommendations is generated using a generative artificial intelligence model of the one or more trained performance analysis models and based on the at least a portion of the predictive performance data set for the analytical unit.

8. The computer-implemented method of claim 7, wherein the performance improvement recommendations comprise training data for the analytical unit, wherein the training data is generated in response to determining that the unit performance data for the analytical unit fails to satisfy one or more performance targets.

9. The computer-implemented method of claim 8, further comprising:
generating, by the generative artificial intelligence model, a training engine comprising the training data for the analytical unit.

10. The computer-implemented method of claim 8, further comprising:
generating an alert in response to determining that the unit performance data for the analytical unit fails to satisfy the one or more performance targets, wherein generating the alert comprises displaying a visual indicator via the one or more renderable virtual widgets.

11. The computer-implemented method of claim 1, wherein generating the predictive performance data set further comprises:
generating aggregated data set comprising unit performance data set associated with one or more second analytical units; and
generating based on the unit performance data for the analytical unit and aggregated data set, a portion of the predictive performance data set by comparing matching portions of the unit performance data and the aggregated data set, wherein the portion of the predictive performance data set is indicative of a performance of the analytical unit with respect to one or more performance categories and the one or more second analytical units.

12. A system for predictive performance analysis, the system comprising one or more processors and at least one non-transitory memory comprising instructions that, with the one or more processors, cause the system to:
receive, from one or more data sources, unit performance data for an analytical unit;
apply the unit performance data to one or more trained performance analysis models to generate a predictive performance data set for the analytical unit by analyzing the unit performance data using the one or more trained performance analysis models;
generate one or more renderable virtual widgets comprising one or more representations of at least a portion of the predictive performance data set for the analytical unit; and
display the one or more renderable virtual widgets on a screen of a user device.

13. The system of claim 12, wherein the user device comprises an augmented reality device, wherein the system is further caused to:
detect a first location in a field of view of the augmented reality device within a spatial region associated with the analytical unit, wherein displaying the one or more renderable virtual widgets on the screen of the user device comprises displaying the one or more renderable virtual widgets on the screen of the augmented reality device in response to detecting the first location of the augmented reality device, wherein the at least a portion of the predictive performance data set for the analytical unit comprises a portion of the predictive performance data set that is associated with the first location;
detect a second location in the field of view of the user device within the spatial region; and
in response to detecting the second location, display, on the screen of the augmented reality device, one or more representations of a second portion of the predictive performance data set that is associated with the second location.

14. The system of claim 12, wherein displaying the one or more renderable virtual widgets on the screen of the user device comprises displaying the one or more renderable virtual widgets in an interface on the screen of the user device.

15. The system of claim 14, wherein the interface includes at least one communications interface element, wherein the system is further caused to:
in response to user interaction with the communications interface element, cause rendering of a communications widget on the screen of the user device to facilitate transmitting and/or receiving of messages between the user device and a second user device.

16. The system of claim 12, wherein receiving the unit performance data comprises:
receiving client performance data comprising a plurality of individual unit performance data associated with a plurality of analytical units; and
applying the unit performance data to the one or more trained performance analysis models to identify the unit performance data from the plurality of individual unit performance data.

17. The system of claim 12, wherein generating the predictive performance data set for the analytical unit comprises:
applying the unit performance data to a first trained performance analysis model to generate a first subset of the predictive performance data set, wherein the first subset of the predictive performance data set includes performance metrics insights; and
applying the performance metrics insights to a second performance analysis model to generate a second subset of the predictive performance data set, wherein the second subset includes performance optimization insights.

18. The system of claim 12, wherein the one or more representations of the at least a portion of the predictive performance data set for the analytical unit includes a textual representation of performance improvement recommendations for the analytical unit, wherein the textual representation of the performance improvement recommendations is generated using a generative artificial intelligence model of the one or more trained performance analysis models and based on the at least a portion of the predictive performance data set for the analytical unit.

19. The system of claim 18, wherein the performance improvement recommendations comprise training data for the analytical unit, wherein the training data is generated in response to determining that the unit performance data for the analytical unit fails to satisfy one or more performance targets.

20. The system of claim 19, further comprising:
generating, by the generative artificial intelligence model, a training engine comprising the training data for the analytical unit.
